(19) United States
(12) Patent Application Publication
(10) Pub. No.: US 2003/0093347 A1
(43) Pub. Date: May 15, 2003

(54) Managing risk using macro-financial risk analysis

(76) Inventor: Dale F. Gray, Bethesda, MD (US)

Correspondence Address: FOLEY HOAG, LLP, PATENT GROUP, WORLD TRADE CENTER WEST, 155 SEAPORT BLVD, BOSTON, MA, 02110, US

(21) Appl. No.: 10/268,042

(22) Filed: Oct. 9, 2002

Related U.S. Application Data
(63) Continuation-in-part of application No. 09/809,768, filed on Mar. 15, 2001.
(60) Provisional application No. 60/189,474, filed on Mar. 15, 2000.
(60) Provisional application No. 60/327,284, filed on Oct. 9, 2001.
(60) Provisional application No. 60/330,768, filed on Oct. 30, 2001.
(60) Provisional application No. 60/392,224, filed on Jun. 28, 2002.

(51) Int. Cl. G06F 17/60

(52) U.S. Cl. 705/35

(57) ABSTRACT

The disclosed technology enables a software application program, executed by a processor of a digital data processing device, to analyze and model economic/financial risk associated with sovereigns, financial sectors, non-financial sectors, and/or investment portfolios. The disclosed technology can calculate and assess, for example, contingent claim values, asset values, volatilities, default barriers, and monetary parameters from financial and macroeconomic data associated with government and monetary authorities and can use such calculations to calibrate risk models and generate economic balance sheets for an economy useful in valuation, risk and vulnerability analysis, risk mitigation, design of investment strategies, and policy analysis and design.

### RELATED APPLICATIONS

This is a continuation-in-part of U.S. patent application Ser. No. 09/809,768, filed Mar. 15, 2001, which is a nonprovisional of U.S. provisional patent application number 60/189,474, filed Mar. 15, 2000. This also claims priority to and the benefit of U.S. provisional patent application No. 60/327,284, filed Oct. 9, 2001; U.S. provisional patent application No. 60/330,768, filed Oct. 30, 2001; and U.S. provisional patent application No. 60/392,224, filed Jun. 28, 2002. Each of the provisional and nonprovisional patent applications identified above are incorporated herein by reference in their entirety.

### TECHNICAL FIELD

The disclosed technology relates generally to risk management and more particularly to modeling economic and financial risk using financial engineering tools, contingent claims, and macro-financial risk analysis.

### BACKGROUND

International financial institutions, governmental agencies, central banks, investment banks, multinational corporations, and other entities in both the public and private sectors that are involved in international commerce are interested in minimizing their risk of financial loss during economic crises within a region (e.g., Europe), country, and/or industry sector. For example, investment banks are typically interested in forecasting and preemptively responding to economic crises that affect the profitability of foreign exchange trading or investment positions (such as that experienced in Korea). In contrast, central banks and some other international financial institutions are interested in forecasting and preemptively responding to major balance of payments crises, such as significant shifts in exchange rates and/or foreign exchange reserves, that require corrective policy adjustments.

Other areas of concern include debt crises (such as that experienced in Pakistan and Argentina), banking crises (such as that experienced in Asia), and other types of crises, which can be independent or interdependent on each other and/or on the financial sector of an economy. The manner in which such individual crises are handled can also introduce other economic stresses or unwanted “side effects” that delay economic recovery.

Unfortunately, the models and analytical tools used in traditional macroeconomics are primarily based on an income and flow framework that is incapable of comprehensively measuring risk exposure. Modern risk management models (e.g., “value-at-risk” model) that are designed to assess portfolio risk based on assumptions/forecasts about the likelihood of outcomes that might put a firm's capital at risk and thus ultimately risk its solvency have recently proven ineffective in warning risk managers and top managers of growing vulnerabilities, resulting in economic turbulence. The failings of such models may be due to faulty assumptions about the probability of adverse events and the correlations and joint probability of such events.

Accordingly, significant effort is being expended to develop new models and/or enhance existing models so as to provide an early warning of economic vulnerabilities and to assist entities that may be adversely affected by these vulnerabilities in managing their risk.

### SUMMARY

The disclosed technology can supplement existing risk management tools by, for example, modeling sovereign risk and assessing value changes (e.g., of assets, debt and equity of governmental and/or monetary authorities) that are interlinked with various aspects of an economy. The disclosed technology can be applied to, for example, valuation, sovereign and country risk analysis, risk management of a portfolio, risk intermediation strategies, surveillance and/or policy analysis. In order to avoid confusion, a new term has been coined to describe this new risk management approach/capability, macro financial risk framework.

In one embodiment, the disclosed methods and systems for assessing and/or managing risk can be embodied in a software application program that includes instructions that affect the operation of a processor in a digital data processing device. The processor can execute one or more of the instructions to access macroeconomic and/or financial data (e.g., corresponding to a government, monetary authority, and/or other sector), calculate at least one contingent claim value associated with the macroeconomic data, calibrate at least one parameter associated with a risk model using the contingent claim value, calculate equilibrium values associated with the risk model, form at least one economic balance sheet using the contingent claim value and/or the equilibrium values of the risk model, and/or display at least one entry of the economic balance sheet (e.g., data associated with equilibrium values) in a user interface of the digital data processing device.

In one embodiment, one or more economic balance sheets can be formed using one or more contingent claim values. A first economic balance sheet can include data corresponding to a first sector and a second economic balance sheet can include data corresponding to a second sector, where at least some of the data from the first and second sectors can be associated (e.g., linked) with each other.

The contingent claim value can be associated with a monetary transactions value, money, and/or correspond to an implicit call option on the assets of at least one of a government and/or a monetary authority. The contingent claim value can also be determined from a default barrier, a monetary transactions value, an amount of RM (defined in Detailed Description Section), a real exchange rate, a sovereign local currency debt, and/or a price index. The monetary transactions value can be estimated using one or more foregone incomes.

The calibrated parameter associated with the risk model can be a share of near term debt, a share of long term debt, a volatility of a liability, a policy effectiveness parameter, a risk free discount rate, a sovereign risk premium, a default recovery rate, an asset correlation parameter and/or a tail factor.

### BRIEF DESCRIPTION OF THE DRAWINGS

The foregoing discussion will be understood more readily from the following detailed description of the disclosure, when taken in conjunction with the accompanying drawings in which:

FIG. 1 schematically illustrates an exemplary system suitable for macro financial risk analysis and modeling;

FIGS. 2A-B illustrate an exemplary methodology used in operating the exemplary system of FIG. 1; and

FIG. 3 illustrates an exemplary graphical display generated by the system of FIG. 1 while following the methodology of FIGS. 2A-B.

### DETAILED DESCRIPTION

For convenience purposes, some exemplary descriptions of terms are provided herein, although those skilled in the art will understand that these are not provided as limiting definitions, but rather as illustrative examples of the scope of said terms; further alternative and supplemental illustrations and descriptions are found in references, such as “Financial Programming and Policy,” by the IMF Institute, 2000, in “Finance” by Bodie and Merton (20002), or in “Options Futures and Other Derivatives,” by John Hull, fourth edition 2000, which are incorporated herein by reference. None of these further descriptions and illustrations are intended to limit, in any way, the meaning of the terms or would be understood by one of skill in the art upon reading this description and the associated claims.

“Economic entity” can include a firm, corporation, financial institution, bank, financial intermediary, insurance company, financial-industrial group, central bank, government, household, monetary authority, international financial institution, person, or any other type of legal entity. A “sector” can be one or more economic entities.

“Asset” can refer to the property and/or resources of one or more economic entities, which can have a cash value and can be used to pay the debts of the economic entity. “Expected asset value” can refer to the mean asset value at a time in the future, and the distribution of an asset can refer to the probability that an asset will have a certain value at a certain point in the future. “Debt” can refer to an obligation of one economic entity to pay another economic entity.

The “debt of economic entities” can include a structure and maturity of debt owed (e.g., long term, short term, domestic currency, and foreign debt) and shares of debt owed to financial institutions by economic entities. The debt of financial institutions associated with monetary authorities can include debt and deposits. Further alternative and supplemental illustrations and descriptions of assets, liabilities, and debt of economic entities or other macroeconomic aggregates can be found in “Financial Programming and Policy,” by the IMF Institute, 2000.

A “contingent claim” can refer to an asset whose future payoff is contingent (i.e., depends) on the outcome of some uncertain event. For example, a contingent claim can be associated with the equity of a levered firm modeled as a call option and/or a contingent claim can be associated with a financial guarantee that can be modeled as a put option. Other alternative and supplemental illustrations and descriptions of contingent claims can be found in “Finance” by Bodie and Merton.

“Macro Financial Risk (MFR)” analysis can refer to an analysis of economic value changes, risk and risk transmission for economic entities, groups of economic entities, and/or sectors in an economy that can use the values of IADs (see definition below) and/or measures of credit risk, devaluation risk and value changes that can be derived from analysis of the relation of assets to default barriers for such entities, groups of entities and/or sectors. MFR is an embodiment of the disclosed technology.

“Macroeconomic parameters” can include macroeconomic variables, such as one or more exchange rates, interest rates in a country, interest rates outside a country, government net fiscal revenues, gross domestic product of an economy, etc. These parameters can also include other macroeconomic indicators, macroeconomic aggregates, and/or prices as discussed in “Financial Programming and Policy” by the IMF Institute, 2000.

An “option” can be a subset of a derivative. A “derivative” can refer to an instrument, product, and/or asset whose value is derived from another instrument or asset. There are generally two types of implicit or explicit options, a call option and a put option. A call option can refer to an option to buy an associated (underlying) instrument, product and/or asset and a put option can refer to an option to sell an associated (underlying) instrument, product and/or asset. The “delta of an option” can refer to a change in an option value relative to the value of the underlying instrument, product, and/or asset and the “gamma of an option” refers to a change in the delta relative to the underlying asset. The “vega of an option” refers to a change in the value of the option for a change in a volatility of the underlying asset.

“Macro financial risk parameters” can refer to parameters and/or factors for an economic entity, group of entities, and/or one or more sectors that can include, for example, a share of near term debt payable before time “t” for an economic entity or group of entities or sector, a long term debt factor (see definition of default barrier), one or more policy effectiveness parameters (see definition of PEPs), a risk free discount rate, a sovereign risk premium (e.g., interest rate spread on sovereign debt reflecting sovereign risk), one or more standard deviations of probability distributions of assets or combined assets, one or more recovery rates after default, one or more asset correlation parameters for two or more assets, and/or a tail factor to increase the size of the tail of a normal or lognormal probability distribution.

“Interlinked Aggregate Derivatives (IADs)” can refer to a mathematical methodology that can be used to a) calculate an economic value associated with one or more implicit economic rights, and/or b) exchange a portion of assets, a portion of debt, and/or an implicit economic obligation in a particular time period. The mathematical methodology can include or otherwise be associated with formulas that can calculate the value or price of a derivative (e.g., the Black-Scholes formula, American option pricing formulas, binomial tree calculation approaches, and/or trinomial tree calculation approaches).

“Interlinked aggregate derivative financial sector put option” can refer to a subtype of IAD whereby a portion of the assets, and a portion of the debt and deposit liabilities of a financial institution can be transferred to another economic entity, usually a government and/or monetary authority. An IAD financial sector put option can include a portfolio or group of IAD put options from firms that may have loans with a financial institution. The value of the IAD financial sector put option can represent an implicit economic benefit to the financial institution or groups of financial institutions, and can represent an implicit cost to the government and/or monetary authority. “Interlinked aggregate derivative call option” can refer to a subtype of IAD that can measure an economic value to exchange assets minus debt for a group of firms or financial institutions.

“Policy effectiveness parameters (PEPs)” can refer to a factor (e.g., that may vary from 0 to 1) that can be multiplied by an underlying asset value, debt value, and/or default point value in an IAD methodology. PEPs can represent incomplete exchanges and/or payments and thus can affect an economic value of interlinked aggregate derivatives. One exemplary type of PEP can be associated with an effectiveness of an insolvency system in a particular country, where the PEP can correspond to a designated minimum share of assets transferred to holders of debt in the event that debt payable in the near term, before time “t,” is not or cannot be paid by firms or groups of firms.

“Time period” can refer to a variable time interval (e.g., a time horizon), which can be used for calculating various values and/or can otherwise be used in formulas.

“Asset Default Barrier Gap (ADBG)” can refer to an expected value of assets at the time horizon minus a default barrier at the time horizon divided by a standard deviation of the asset value of an economic entity, group of economic entities, and/or sector. ADBG can measure a risk associated with a default or events occurring when assets are less than or equal to default barriers. ADBG can correspond to a number of standard deviations of asset value that the mean asset level is away from a default barrier at a specific time. The probability of default can be measured by a proportion of a probability distribution that is less than the default barrier.

“Default barrier” can refer to a near term debt payable plus a long term debt factor times a long term debt payable. When assets are equal to or less than a default point, an entity can be deemed to be in default on its debt obligations. A default barrier can vary according to one or more of the following factors: exchange rates, interest rates in a country, interest rates in other countries, a share of near term debt exchanged for long term debt, and/or other factors.

A “combined asset value” for an economic entity can be determined by adding assets to interlinked aggregate derivatives of the entity that have the characteristics of an asset. A “combined value of variable default barrier” can be determined by adding a default barrier of an entity to interlinked aggregate derivatives of the entity that have the characteristics of debt and/or liabilities.

A “devaluation” can refer to a change in an exchange rate, which is the rate at which a monetary authority exchanges local currency for foreign currency. “Distance to devaluation,” for a monetary authority, can refer to the assets of the monetary authority minus the point (equal to a factor multiplied by the default barrier of the monetary authority), and divided by a standard deviation of the asset value of the monetary authority. If the assets of the monetary authority are equal to or below such point, a devaluation of the exchange rate can occur.

“Credit risk” can refer to the risk that an economic entity will default on debt obligations.

“Aggregation” can refer to a method of aggregating financial data, such as an average of key financial components of entities in a group or the financial data of proxy firms/entities that are representative of a larger number of entities.

“Risk adjusted discount rate” can refer to a discount rate that can be used to discount cash flows of a risky asset or liability of an entity, such as an asset value of a corporation that discounts free cash flow. This risk adjusted discount rate can be determined from one or more of a risk free rate, a sovereign spread, a beta, and/or a measure of the ratio of a volatility of the equity market in one country relative to another country.

“Policy analysis” can refer to an analysis of the impact of one or more of the following policy types: economic, financial, macroeconomic, legal, regulatory, structural, aggregate swaps, restrictions, exchange rate regime, monetary policy procedure, etc.

The following descriptions correspond to the use of these terms as set forth by the International Monetary Fund in its Macroeconomic Accounting, including but not limited to Currency (CY) plus Bank reserves (R) by Monetary Authorities, Net Foreign Assets, Net Domestic Credit, Primary Deficit, M1, M2, Domestic Nominal Debt, Price Level, Domestic Credit to Sectors, Net Government Revenues, Real Exchange Rate, Monetary Transactions Value, Output, Velocity, current account, foreign exchange reserves, and others. (See Macro Economic Accounts, Analysis and Forecasting, IMF Publications, which is incorporated herein by reference)

For purposes of the following description of exemplary embodiments of the disclosed technology, the following terms are used in formulas:

κ=fraction of RM supply in call option formula

RM=(z*(CY+R))+CCVM, where z is the fraction (e.g., between zero and one) of currency and central bank reserves (R)

CCVM=contingent claim value of money (=max((FXRes−FloorFXRes)*Exchange Rate_{T}−(CY+Dep)), as described below

D_{DG}=sovereign local currency debt

P_{$}=Foreign (US) price index

RER=Real exchange rate as defined by IMF

P_{LC}=Price index in country (local price index)

_{$}ImV_{G+CB,0}=Implied sovereign assets

N( )=cumulative normal distribution

D_{FGNT}=Sovereign foreign debt due in near-term, usually one year, plus interest and amortization on long term debt

α_{GF}=factor to discount (D_{FGLT}) which varies by maturity & duration of D_{FGLT}

S_{SOVFX} sovereign spread over US treasuries.

D_{FGLT}=sovereign foreign debt that has maturity greater than near-term sovereign debt D_{FGNT}

ELL=equity like liabilities of sovereign (defined here as government plus monetary authorities)

e^{-r*τ}=exponential e to power of −r* times time τ

_{$}σ_{FXELL}=dollar or foreign volatility of ELL=(κRM +D_{DG}) adjusted by exchange rate to be in dollar or foreign currency terms _{$}σ_{AGCB}=volatility of _{$}ImV_{G+CB,0}

σ_{ELL}=volatility of ELL=(κRM+D_{DG})

σ_{ER}=volatility of exchange rate

ρ_{ER,ELL}=correlation of ELL and exchange rate

r*=foreign risk free rate of interest (US)

r=risk free rate of interest in country (government default free bills)

τ=time horizon for option and other formulas

*NFA_{MA}e_{N,0}=net foreign asset of sovereign or foreign exchange reserves

IMF/CCL=contingent foreign exchange reserves derived from the IMF, any contingent credit lines, and/or from present and future current account surpluses

λ DA adjustment factor (for skew) times DA, implied fiscal asset (present value of fiscal surpluses)

e_{N,τ}=forward exchange rate at time t in local currency per foreign currency unit ($)

e_{N,0}=spot nominal exchange rate at time t=0 in local currency per foreign currency unit ($)

For floating exchange rate: 1/e_{N,τ}e_{N,τ}(1/e_{N,0})e^{(r*-r-risk premium)τ}

For fixed exchange rate: 1/e_{N,τ}=(1/e_{N,0})

“Risk premium” can refer to a difference in local and foreign interest rates that can account for a divergence from interest rate parity (risk premium=0 occurs when interest rate parity holds). “Other Default Barrier” can refer to a default barrier that can include sovereign, government, and/or public sector liabilities, whether implicit or explicit.

Risk and/or vulnerability measures can be computed for one or more processes and calibrations of assets, liabilities and contingent claims that can pertain to an economy, sector, sub-sector, and/or individual entity. At least some of exemplary risk and vulnerability measures are described below.

“Option Sensitivity to an Underlying Asset (Delta)” A delta can refer to a change in the value of an implicit option with a change in the value of the underlying asset. The value that delta measures can represent an exposure to the option, e.g. the government's exposure to the value of its guarantee as banking assets change. The term “hedge ratio” can be used to represent delta and pertains to the activities of investors who hedge their positions in put options by buying shares in an underlying stock. Because the price of a put option rises as the value of an underlying asset falls, an investor who owns one put option, and wishes to hedge, will buy a larger number of shares of the underlying asset as the price of the asset drops lower. The “hedge ratio” increases as the value of the underlying asset falls.

“Other Option Sensitivities,” such as a “gamma” of an option can refer to a change in the delta for a change in the underlying asset. Delta can correspond to the “slope” in a graph of an option value versus an asset value and gamma can correspond to the “convexity.” The “vega” of the option can correspond to the sensitivity of the option to a change in the volatility of the underlying asset.

“Spreads on Debt” can refer to credit spreads on debt that can be calculated using formulas derived from option equations. This spread can be a function of the leverage ratio, volatility of assets, time, and/or risk-free interest rate. The leverage ratio can correspond to the ratio of an asset to the present value of a default barrier, e.g., the default-free debt value.

“Probabilities of Default” can refer to probabilities of default that can be calculated from option formulas and can be used for the valuation of risky debt, credit default swaps, and/or derivatives.

“Measuring Risk Exposures in Risky Debt” Even if loans are currently marked-to-market, it may be beneficial to measure/assess the future risk exposure of such loans. The amount of money that one can reasonably expect to lose as a result of a default over a given period can be referred to as the “expected risk exposure.” The probable loss can depend on: (i) the amount exposed to credit risk; (ii) the probability of a counterparty defaulting, and/or (iii) a recovery rate.

“Distance to Distress” can correspond to a measure of default risk or distress for an entity or sector. The distance to distress measure can equal an asset value minus a default barrier divided by an asset volatility times the asset value.

“Value-at-Risk and Other Indicators” Value-at-Risk can measure the maximum amount likely to be lost over a specific time period for a given confidence level. A variety of other risk indicators can include sensitivity of distance to distress and sensitivity of implicit put and call options to changes in underlying parameters (e.g., exchange rates, interest rates, asset values, volatility, time, etc.).

Traditional macroeconomics focuses primarily on capital flows and stocks with only a limited analysis of accounting balance sheets. In contrast, the disclosed technology uses, at least in part, contingent claims analysis to form economic balance sheets of industry sectors and/or of the government and monetary authorities, which provides an important framework for analyzing value changes in a sector and between sectors (including the government and monetary authority sector) that can be used separately and in conjunction with flow-income accounts and accounting balance sheets.

The disclosed technology can calibrate approximate economic balance sheets for corporate sectors, financial sectors, and/or for a sovereign entity (defined here to be the government plus monetary authorities). The disclosed technology can use different inputs than a discounted cash flow approach, which discounts expected cash flows using risk-adjusted discount rates. For example, the disclosed technology can calculate the value of a particular security or asset from knowledge of the prices of one or more related securities or assets and their volatilities. The sum of the market value of such claims equals the market value of the assets of the sector. This calibration process has not been previously applied at the “macro” level to sectors or to governments and monetary authorities. This calibrated model can then be run “forward” to estimate how values of senior (e.g., debt) and junior claims (e.g., equity), as well as, potential credit risks may change as underlying asset values, asset volatilities, debt related default barriers, or other parameters change. This “forward” process can be applied to sectors of an economy, to the government and monetary authority sector, and/or to an analysis of interlinked sectors of an economy.

The disclosed technology provides several new capabilities over traditional economic analysis techniques that are not obvious to those skilled in economics and finance, for example, the disclosed technology can (i) link the foreign and domestic assets of government and monetary authorities via option/contingent claim formulas and value the claims and liabilities issued by the government and monetary authorities (money, domestic government debt, and sovereign debt) using equilibrium relationships that link macroeconomic variables; (ii) account for the transmission of value changes and risk of default between sectors; (iii) account for the value of money for transactions as well as value from claims on domestic and foreign assets; (iv) evaluate sovereign default risk between sectors before crises in a manner that links such risk to value changes, monetary policy, exchange rates, price levels and/or other macroeconomic variables; (v) quantitatively describe macroeconomic variables, exchange rates, price levels, output, volatilities and equilibrium and links to sovereign credit risk with option formulas and relationships, as well as, the affects on risk and risk transmission of certain policy actions by the government or monetary authorities.

The disclosed technology also provides several additional advantages, such as (i) allowing for the calculation of correlation of values of assets, value of money stock, domestic government debt, sovereign foreign debt value changes and correlation of defaults across sectors and asset classes; (ii) quantifying the rate of change of values and risk in response to certain macroeconomic variables such as exchange rates, capital flows, inflation expectations, and/or providing a new quantitative balance sheet framework illustrating the equilibrium value of the government and monetary authority assets, debt and equity; (iii) calculating a probability of devaluation and/or abandoning a specified price level and inflation target.

The disclosed technology evaluates the values of debt, equity-like liabilities, assets, and/or equilibrium in prices and exchange rates through valuation, as a contingent claim on government/monetary authority assets and value, and integrates the same with contingent claims and implicit options in other parts of the economy.

Contingent Claim and Monetary Value of Government and Monetary Authorities in a Country

The total market value V(t) of a sector, including the government and monetary authority sector, is equal to the market value of junior claims and senior claims, including risky debt and other explicit or implicit liabilities. These junior and senior claims can be represented as E(t)+D(t), which is equal to total assets (including stochastic asset A(t)) plus any “excess capital” reserves R (risk capital as a cushion for unexpected losses or as signaling capital to signal the financial health of the entity). If assets decline below the point where debt cannot be paid, default results. The exact point where default occurs, called the default barrier (DB), is the face value of the debt (adjusted for the accrued interest and maturity structure of the debt) plus other explicit or implicit senior liabilities. Holders of junior claims, such as equity, have a contingent claim on the residual value of assets in the future, which is the maximum of either assets minus debt, or nothing. So junior claim (or equity), E(t) at time T, is E(T)=max [A(T)−DB, 0]. The market value of risky debt can be modeled as D(T)=min [A(T), DB]=DB−max [DB−A(T),0]. The total value of the entity at time T can be represented as: V(T)=A(T)+R=E(T)+D(T)=max [A(T)−DB, 0]+DB−max [DB−A(T),0]. This relationship can be restated in terms of implicit options, as follows: Total Market Value=Asset Value+Reserves=Implicit Call Option+DB−Implicit Put Option (This framework can be expanded to encompass multiple classes of claims.)

The disclosed technology uses these relationships to construct economic balance sheets of sectors, including the government and monetary authority sector. The market value of assets (Total Market Value=Asset Value+Reserves) equals the market value of junior claims (Implicit Call Option) plus the market value of debt (DB−Implicit Put Option). The accounting balance sheet is a special case of the economic balance sheet—the case where volatility of assets is assumed to be zero and total face value of debt is reported and thus assets equal book liabilities plus net worth.

The disclosed technology applies a contingent claims framework to the government (G) and monetary authorities (MA) of any economy. The disclosed technology incorporates a methodology of how government and monetary authorities issue contingent claims or “Equity-Like Liabilities” (_{LC}ELL₀)−money (RM=z times (Currency plus Bank Reserves held by MA) +CCVM) and nominal domestic debt issued by the Government. These contingent claims are implicit call options on assets of government G and monetary authorities MA, with part of the value of the contingent claims derived from their monetary transactions value (MTV) in use in transactions as “mediums of exchange.” Contingent claim value of money (CCVM) can be a junior claim and can be modeled as a vulnerable call option. Currency, CY, has special characteristics and can be used for monetary transactions and as a store of value (MTV). Currency can also be exchanged for foreign currency reserves. Accordingly, monetary authorities can be deemed to have a contingent obligation to exchange local currency (CY) and bank deposits (Dep) for foreign exchange (which has a foreign currency value, FCV), if there are reserves left after payment of other more senior claims and if such monetary authorities allow it.

Thus, currency can be modeled as max (CY+Dep, FCV) which is the same as CY+Dep+max (FCV−CY,0). The last part of the equation (max (FCV−MTV,0)) can be modeled as a vulnerable call option, if the government is willing to exchange sufficient foreign currency assets for local currency. Deposits, net of reserve requirements, also have a vulnerable call option value.

Together deposits and currency can be modeled as:

max (CY+Dep, FCV,)

=CY+Dep+max ( (FXRes−FloorFXRes)*Exch Rate_{T}−(CY+Dep))

=CY+Dep+CCVM

For the purposes of this disclosure, RM equals (z times (CY+R))+CCVM, where z is the fraction, between zero and one, of currency and central bank reserves (R). The level of z and CCVM depends on the country and the capital control regime in place in the country, and may change over time.

The value of ELL_{G&MA} can be derived from (call option on G/MA assets)+MTV, =ƒ (Foreign Assets & Domestic Assets, σ_{AGCB} (volatility of assets), r (nominal risk free interest rate), t is time, and strike price related to “real” debt (foreign debt or indexed debt) related default barrier)+MTV.

Foreign and domestic assets are assets or portfolios of assets held by the government and monetary authorities. Foreign assets comprise NFA (net foreign assets) and/or contingent (callable) assets for IMF or another contingent credit line and contingent reserves can be derived from future current account surpluses. Domestic assets are domestic fiscal assets (PV of revenues less expenditures), a short put option on financial sector assets, and/or domestic financial sector credit assets (domestic credit minus the liquidity support credit event option).

In order to calculate the value of the components of the aforementioned relationship, values are placed in a common numeraire. The use of foreign currency value as the numeraire introduces the exchange rate. More particularly:

“Value” of currency=Value of contingent claim on assets of govt. & MA including monetary transactions value (in terms of $ or foreign currency)/stock of “equity like liabilities.” This relationship is analogous to:

Price of the “stock” in dollars per local currency

=Value of the total “stock“/Number of shares of “stock” issued

1/e_{N}=1/exchange rate in LC/$ (or foreign currency FX)

=Call option (on _{$}V_{G+CB,0} the $ value, or FX value, of assets of the government and monetary authorities (both domestic LC assets and FX assets) with the strike price equal to or related to the foreign currency or indexed sovereign debt or other default barrier, plus the Monetary Transactions Value, MTV, of call option or contingent claim] / number of shares of “stock” issued, which is equal to the amount of reserve money RM of the monetary authorities and nominal government debt issued by the government, D_{DG}

_{$}C=max [_{$}V_{G+CB,0}−{Default barrier related to foreign debt or indexed debt or other default barrier},0]

=Call value described above.

Money has a large monetary transactions value plus value as a contingent claim CCVM. Nominal domestic default free debt, paying nominal interest rate q, is a contingent claim on government and MA assets (plus some possible monetary transactions value) akin to “dividend paying equity” paying dividends of “q” and may have some monetary value as well, depending on the economy and situation. The amount of “equity-like liabilities” of the government and monetary authorities can be represented as:

ELLL_{G&MA}=RM+D_{DG}

The Real Exchange Rate can be represented as RER=e_{N}P_{$}/P_{LC}, or,

RER P_{LC}/P_{$}=e_{N}, P_{$}=the price index of foreign countries like the US and P_{LC}=the price index in another country with local currency (LC) as the currency in use, so inserting in the above equation links the equations to the local currency value and gives,

1/e_{N}=(_{$}C+MTV)/(RM+D_{DG})

1/e_{N}=P_{$}/(RERP_{LC})=(_{$}C+MTV)/(RM+D_{DG})

or equivalently,

(RM+D_{DG})/e_{N}=(_{$}C+MTV)

(RM−MTV+D_{DG})/e_{N}=_{$}C

(κRM+D_{DG})/e_{N}=_{$}C, where κRM RM−MTV

1/e_{N}=_{$}C/(κRM+D_{DG})=P_{$}/(RER P_{LC}).

These aforementioned concepts and relationships can be applied to all forms of processes for the estimation of the above equation and related equations. The disclosed technology can value options and contingent claims using, for example, Black-Scholes, Black-Scholes-Merton, European Option methods, American Option methods, binomial and other tree techniques, and/or other techniques.

The aforementioned concepts can be used to view countries as though they were companies as shown below. Company A, C_{A} issues n_{A} shares of “equity,” and C_{B} issues n_{B} shares of its “equity.” C_{A} can be large (analogous to the US), its assets are in shares of “A's” equity, and its debt is denominated in shares of “A”. C_{B} can be small (analogous to a country with a soft currency like an emerging market), its assets are in shares of “A” equity and “B” equity, and its debt is denominated in shares of “A.” The value of C_{B}'s “exchange rate” is the value of the implicit call option on B's assets (plus the monetary transactions value, analogous to equity options given to some of B's employees) with a strike price related to C_{B}'s debt (debt denominated in shares of A) divided by n_{B}, the number of C_{B}'s shares outstanding. This provides fundamental equilibrium relationships, as follows: if more of C_{B}'s shares are issued (i.e. of RM+D_{DG}) and if the real value of assets is unchanged (right hand side of equation), then the price level P_{$} will increase and/or the exchange rate will depreciate so as to compensate. The contingent claims value equations still hold and they define the equilibrium so that values change in a way that abnormal profits cannot be easily made.

Finance and Contingent Claims Approach to Monetary Transactions Value, Inflation Tax, Velocity of Money, and Monetary Relationships

The disclosed technology can also estimate a component of the MTV from the inflation tax. The value of G/MA assets could fall to, or below, a default barrier, but equity would not go to zero because of the monetary transactions value, which is related to inflation tax and seigniorage value (the willingness of the public to hold money even though it loses value as inflation erodes its value). One measure of a component of the monetary transactions value, MTV, is the inflation tax, Intx_{MA,G}. The inflation tax, Intx_{MA,G}, represents revenue “earned” by the monetary authorities and government on the reserve money and, in some cases, on nominal government debt, because inflation erodes part of the purchasing power of the money or nominal debt (if inflation is higher than the rate paid on the nominal debt). The inflation tax can be calculated by (π/(1+π))M=(1−exp(−π)M, where M is the relevant monetary stock variable. Commercial banks may also earn some inflation tax revenues Intx_{B}, so, (π/(1+π))M=(1−exp(−π)M=Intx_{MA}+Intx_{B}. The inflation tax earned by the monetary authorities can be derived from the RM component of M, as (π/(1+π))RM=(1−exp(−π)RM. However, due to interbank competition, the government and monetary authorities may earn more or less than this value, so a more general statement of the monetary authorities inflation tax revenues can be a fraction f₁ of the total Intx_{MA}=f₁(π/(1+π))M=f₁(1−exp(−π)M=f₁(Intx_{MA}+Intx_{B}). The inflation tax on nominal government debt is ((π−r)/(1+π))D_{DG}=(1−exp(r−π)D_{DG}). For the rest of this disclosure, the Intx_{MA,G} will be used, where Intx_{MA,G}=f₁(π/(1+π))M.+((π−r)/(1+π))D_{DG}=f₁(1−exp(−π)M +(1−exp(r−π)D_{DG}).

The disclosed technology can estimate the MTV in the contingent claims implicit call option formula with a component being Intx_{MA,G,}, which is the amount that the holders of money issued by the monetary authorities are willing to pay in foregone income by holding the money and the amount that the holders of government nominal debt issued by the government are willing to pay in foregone income by holding the debt.

The Intx_{MA,G} can be in units of foreign currency, so _{$}Intx_{MA,G}=Intx_{MA,G} /e_{N}.

Thus,

_{$}C+_{$}Intx_{MA,G}=(RM+D_{DG})/e_{N}=P_{$}(RM+D_{DG})/(RER P_{LC})

or

_{$}C=(RM−Intx_{MA,G}+D_{DG})/e_{N}=P_{$}(RM−Intx_{MA,G}+D_{DG})/(RER P_{LC}).

These equations lay out fundamental equilibrium relationships. For example, if more shares are issued (of RM+D_{DG}), the real value of _{$}C (may or may not change) equals the right hand side of the equation and the price level P_{$} and/or the exchange rate e_{N} will increase to compensate so that the value equations still hold.

The processes of the disclosed technology use contingent claims implicit option formulation of money value and money velocity. As previously described, the foregone revenues, equal to the inflation tax, represent payment for money, where money is a call on goods and services, which is directly related to utility, with a strike price payment of the inflation tax (cost of erosion of value of money due to the inflation tax).

The growth rate of utility U is related to the growth rate of real income (Y), and the expected value of U is directly related to or equal in effect to real income Y. Inflation is the growth in the price level and is defined as π, and expected inflation as π′.

Value of money=Mₙ=max[Uₒ−(π′/(1+π′)) Mₙ, 0]

The disclosed technology can be used with all types of methods of estimating option values, such as the Black-Scholes-Merton (BSM) formula. Thus,

Value of money=Mₙ=UₒN(d₁)−(π′/(1+π′))Mₙe^{-r*τ}N(d₂)

Money is a call on goods and services which is directly related to utility with a payment of the loss of value due to erosion of value due to the inflation tax (note that π′Mₙ could be used if inflation is low, but (π′/(1+π′)) Mₙ is preferable to cover all situations even if there is hyperinflation.). The units of Uₒ are in utility per basket of goods and M is in LC, local currency, thus the value of U₀ can be converted into units of LC/basket of goods, by Mₙ=PUₒ N(d₁)−(π′/(1+π′)) Mₙe^{-r*τ}N(d₂)

Assuming that economic financial utility is directly related to the amount of output in the economy, Uₒ=f_{1Y} Y, Y=real output, if factor f_{1Y}=1

Mₙ[(1+(π′/(1+π′)) e^{-r*τ}N(d₂))/N(d₁)]=Y P

MₙV=P Y

Income Velocity of Money=V=[(1+(π′/(1+π′))e^{-r*τ}N(d₂))/N(d₁)]

σ_{PY}=(σ²_{Y}+σ²_{π}+2 ρ_{Y,π} σ_{Y}σ_{π})^{½}

d₁=[1n (PY/πMₙ)+(r+2 ρ_{Y,π} σ_{Y}σ_{π}+(σ²_{Y}+σ²_{π})/2)T]/(σ²_{Y}+σ²_{π}+2 ρ_{Y,π} σ_{Y}σ_{π})T^{½} and

d₂=[1n (PY/πMₙ)+(r+2 ρ_{Y,π} σ_{Y}σ_{π}−(σ²_{Y}+σ²_{π})/2)T]/(σ²_{Y}+σ²_{π}+2 ρ_{Y,π} σ_{Y}σ_{π})T^{½}

where σ_{Y}=standard deviation of real output of the economy

σ_{π}=standard deviation of inflation in the economy

ρ_{Y,π}=correlation of real output growth and inflation in the economy.

Macro Financial Risk Framework of Assets and Implicit Options for Interlinked Sectors of Any Economy (Government/Monetary Authority Sector, Financial Sectors, Corporate and Household Sectors)

Sectors of an economy can be modeled as assets, debt, and/or implicit options, in an interlinked way. The equations underlying the conceptual foundation for such a model is described below and Table 1 shows a set of interlinked values across all sectors for an economy.

There are different types of implicit options between entities and aggregate implicit options between groups of entities in sectors. These fit into one of two general types: implicit exchange options or implicit credit event options. Implicit exchange options are options to exchange various assets and debt, a subset are the contingent claim options—equity as an implicit call option and debt containing an implicit put option. Implicit credit event options are equivalent to implicit credit default swaps with payments on certain credit events. One sector can be “long” and another sector can be “short” for each aggregate implicit option. Likewise, the loans, investments and positions of foreign lenders and investors contain various embedded implicit options.

Modeling the value of equity as a call is the same as being long the underlying asset, short the present value of the default free value of debt, and long a put option. The equity value or junior claim value can be derived from the value of assets less the market value of debt (which is the same as the risk free value or, in some cases, book value minus the put option). Thus, if the put value is estimated from the market value of debt or other means, it can be used along with asset value to get the value of equity or net worth.

The values of the aggregate asset put and call options for a sector sum to zero because of the put-call parity relationship nature of options (explicit or implicit options). This put-call parity equivalence is useful in understanding key linkages and it also significantly reduces data requirements. The implied volatility of a European call option is the same as the volatility of the European put option with the same strike price and maturity (this is approximately true for American options as well).

The basic MFR model of net worth of “i” corporate sectors (households are included as one of the corporate sectors), “j” banking/financial institution sectors, and one joint government and central bank sector.

The framework can be equivalent to one formulated with the domestic nominal debt modeled as subordinated debt, instead of equity. In the formulation of contingent claims, equity is a call option on assets, and subordinated debt is a long call option (with a strike price of the lower amount of total debt, i.e. senior debt) plus a short call option with a higher strike price (senior debt plus subordinated debt). The value of senior debt (value to the holders of senior debt) can be modeled as either a short call on the assets plus long the assets, or the more familiar long risk free debt plus short a put option (Holders of equity and subordinated debt and senior debt thus hold equity=Call (Assets, strike=Sr.+Sub. Debt), subordinated debt=−Call (Assets, strike=Sr.+sub Debt)+Call (Assets, strike=Sr. debt), and Sr. Debt holders hold=−Call (Assets, strike=Sr. debt) plus long Assets. A sum of all these equals Assets. The default barrier is foreign debt or “real” debt (such as indexed debt).

Foreign and domestic assets are two main assets, or portfolios of assets, that can be held by the government and monetary authorities. Foreign assets comprise NFA (net foreign assets) and contingent (callable) assets for IMF or other contingent credit line. Domestic assets comprise domestic fiscal assets (PV of revenues less expenditures), a short put option on financial sector assets, and/or domestic financial sector credit assets (domestic credit minus the liquidity support credit event option). The disclosed technology can be used with any formulation where foreign assets and/or domestic assets are modeled as stochastic distribution or distributions, normal, lognormal, including skew and kurtosis parameters for the asset distribution or distributions, or any other formulation.

The MTV can be estimated as Intx_{MA,G} (Note that MTV can be used in place of Intx_{MA,G}.) The government and monetary authorities are long Intx_{MA,G,} and the private holders of “money” are short the inflation tax, but long a call on goods and services which provide them utility. These relationships for the combined government and monetary authorities, and for all major sectors are summarized below.

Contingent Claim of Government and Monetary Authorities

| | |
|---|---|
| −ELL_{G&MA} = | Equity or junior claims (or RM, D_{DG} = |
| −(RM + D_{DG}) | Quasi-Equity or Subordinated Debt, and |
| | claimants to the residual value of the |
| | government in the form of tax refunds, tax |
| | reductions, or claims on incremental |
| | government revenues) |
| +Intx_{MA, G} | Fraction, f_{G}, of inflation tax (see section 3 |
| | above) accruing to government and monetary |
| | authorities |
| +NFA_{G, MA} e_{N} | Foreign Assets |
| +(IMF/CCL) e_{N} | Contingent Foreign Assets (contingent |
| | foreign exchange reserves derived from current |
| | account surpluses) |
| −Σⱼ P_{Bj} + NG_{Rev} + | Domestic Fiscal Assets, includes the sum of |
| ΔNG_{Rev} + (V_{REA G, MA}) | put options Σⱼ P _{Bj} to financial sector, put |
| | options the government is short. Also includes |
| | net govt revenue. |
| −Σⱼ FSCEO_{Bj} + ΣⱼDC_{Bj} | Domestic Financial Sector Credit Assets |
| | includes financial sector credit event options, |
| | i.e. liquidity support from G & A and existing |
| | Domestic Credit to the financial inst. |
| (−D_{FG} + EO_{FG})e_{N} | Default Barrier, FX (“real”) Debt (D_{FG} is |
| | risk free debt and EO_{FG} is an exchange option, |
| | equal to a put option, representing the |
| | credit/default risk) |

The government & monetary authorities are short equity (reserve money and domestic debt), long assets (but embedded in the assets is a short financial sector put option and a short financial sector credit event option), and short foreign or real debt but long the associated “put” or exchange option which is a measure of sovereign foreign credit risk.

Note that these all sum to zero:

−RM − D_{DG} + Intx_{MA, G}
+NFA_{G, MA} e_{N} + (IMF/CCL) e_{N}
−Σⱼ P_{Bj} + NG_{Rev} + ΔNG_{Rev} + (V_{REA G, MA})
−Σⱼ FSCEO_{Bj} + Σⱼ DC_{Bj}
(−D_{FG} + EO_{FG})e_{N}
= 0
For the Financial Sectors:

| −EQ_{Bj} + | Equity of financial sector j, and other long term assets |
|---|---|
| (V_{REA Bj}) | |
| +Σᵢ _{S}ⱼᵢ D _{c, i} | Loans and credit from financial sector j to corporate |
| | sector i |
| −Σᵢ Sⱼᵢ P _{c, i} | Put option associated with risk free loan above |
| +(CY_{Bj} + R_{Bj} + | Currency, Bank reserves held at MA and Domestic |
| D_{DG Bj}) | Govt. Debt. |
| +Intx_{B} | Fraction, f_{B}, of inflation tax accruing to financial |
| | sector |
| +NFA_{Bj} e_{N} | Net Foreign Assets of Financial Sector j |
| +CR_{Bj} | Additional Capital and Reserves |
| +FSCEO_{Bj} | Financial Sector Credit Event Option (liquidity |
| | support) |
| −DC_{Bj} | Domestic Credit from MA/G to Financial Sector j |
| −Dep_{Bj} | Aggregate Deposits of Financial Sector j |
| (−D_{FB}ⱼ + P_{FB}ⱼ)e_{N} | Foreign Loans and credit to financial sector j with Put |
| | option associated with such “risk free” loan |
| +P_{Bj} | Financial Sector Put Option for j, Sum is total for |
| = 0 | G/MA |

| V_{A c, i} + | Value of assets (accounting or implied) plus other |
|---|---|
| (V_{REA c, i}) | assets |
| −D_{c, i} + | Loans and credit from domestic financial sector to |
| P_{c, i} | corporate sector i, plus put option associated with |
| | risk free loan |
| (−D_{F c, i} + | Loans and credit from foreign sector to corporate |
| P_{Fc, i})e_{N} | sector i, plus put option associated with risk free loans |
| ΔNG_{Rev} | Net revenue of govt., fiscal asset |
| = 0 | |

Private Holders of Securities and Liabilities, in aggregate have counter parts:

EQ_{c,1}, EQ_{Bj}

(CY_{OB}+D_{DPvtOB})

−Intx_{MA,G&B}

(+D_{Fc,i}−P_{Fc,i})e_{N}

Dep_{Bj}

(+D_{FBj}−P_{FBj})e_{N}

+D_{FG}−EO_{FG})e_{N}

−IMF/CCL

Table 1 summarizes the sectoral inter-relations of these assets and implicit options.

TABLE 1
Macro Financial Risk Framework Components and Implicit Options
(EQ = ”equity” = call options, P = put options,
EO = exchange options, CEO = credit event options)

| | Corp/Household | Financial | Government & | Private Holders |
|---|---|---|---|---|
| | Sector | Sector | MA | Sec. & Liab. |
| Equity (call | −EQ _{c, i} | −EQ _{Bj} | −ELL_{G&MA} = | EQ _{c, i}, EQ _{Bj} |
| options) | | | −(R + CY + D_{DG}) | (CY _{OB} + D_{DPvtOB}) |
| | | | +Intx_{MA, G} | −Intx_{MA, G & B} |
| Asset Value + | V_{A c, I}(V_{REA c, i}) | (V_{REA Bj}) | | |
| Other Asset Value | | | (V_{REA G, MA}) | |
| Debt (domestic | −D _{c, i} + P _{c, i} | +Σᵢ _{S}ⱼᵢ D _{c, i} | | |
| and foreign) | | −Σᵢ _{S}ⱼᵢ P _{c, i} | | |
| | (−D_{F c,i} + P _{Fc, i})e_{N} | | | (+D_{F c,i} − P _{Fc, i})e_{N} |
| Corporate Options | | (CY _{Bj} + R _{Bj} + | | |
| (Put) | | D_{DG Bj}) + Intx_{B} | | |
| Financial Sector | | +NFA _{Bj} e_{N} | +NFA_{G, MA} e_{N} | |
| Cont. Claims on | | | | |
| G/MA | | +CR _{Bj} | | |
| | | +FSCEO_{Bj} | | |
| NFA - Net | | −DC _{Bj} − Dep _{Bj} | | |
| Foreign Assets | | | | |
| | | (−D_{F Bj} + P_{FBj})e_{N} | | |
| Cap & Oth. Res | | | −Σⱼ FSCEO _{Bj} | |
| | | +P_{Bj} | | |
| Financial Support | | | +Σⱼ DC _{Bj} | |
| (Liquidity) | | | | +Dep _{Bj} |
| Credit from G/MA | | | | |
| | | | | (+D_{F Bj} − P_{FBj})e_{N} |
| Deposits | | | | |
| For. Debt | −ΔNG_{Rev} | | | |
| | | | −Σⱼ P _{Bj} | |
| Financial Sector | | | | |
| Options (Put) | | | | |
| | | | +NG_{Rev} + ΔNG_{Rev} | |
| Fiscal Rev. | | | | |
| (with EO) | | | | |
| | | | (−D_{FG} + EO_{FG})e_{N} | (+D_{FG} − EO_{FG})e_{N} |
| Govt. Debt, | | | | |
| Foreign, with (EO) | | | +IMF/CCL | |
| | | | | −IMF/CCL |
| Pot. IMF/CCL | | | | |
| Financing | | | | |
| | 0 | 0 | 0 | |

Processes to Evaluate Interrelationships, Equilibrium and Valuation between Exchange Rates, Prices, Output and Government and Monetary Authorities Assets and Liabilities and Macro Financial Balance Sheet of Government and Monetary Authorities

The disclosed equations can be used to establish Macro Finance and Relationships from put-call parity. (MTV can be used, in some cases, in place of Intx_{MA,G}.)

_{$}C+Intx_{MA,G}=(RM+D_{DG})/e_{N}=P_{$}(RM+D_{DG})/(RER P_{LC})

=_{$}Put−_{$}V_{G+CB,0}−{D_{FGNT}+α_{GF}(D_{FGLT})}e^{-r*τ}+_{$}Intx_{MA,G}

_{$}V_{G+CB,0}={D_{FGNT}+α_{GF}(D_{FGLT})}e^{-r*τ}−_{$}Put−_{$}Intx_{MA,G}−(RM+D_{DG})/e_{N}

={D_{FGNT}+α_{GF}(D_{FGLT})}e^{-r*τ}−_{$}Put−_{$}Intx_{MA,G}−P_{$}(RM+D_{DG})/(RER P_{LC})

or

P_{LC}=P_{$}(RM+D_{DG})/[RER{_{$}Put+_{$}Intx_{MA,G}−_{$}V_{G+CB,0}

−{D_{FGNT}+α_{GF}(D_{FGLT})}e^{-r*τ}}]

Macro Financial Balance Sheet

The equilibrium relationships based on option and contingent claims pricing produce a valuable new balance sheet formulation for the government and monetary authorities, as described below.

### Market Value of Assets=Market Value of Liabilities =Market Value of Equity Like Liabilities+Market Value of Debt

| Assets | Liabilities |
|---|---|
| Asset value of Government and | “Equity Like Liabilities” |
| Monetary Authorities | Market Value of Real Debt (FX or |
| | indexed debt) Default Barrier |
| _{$}V_{G+CB} + _{$}Intx_{MA, G} | (RM + D_{DG})/e_{N} |
| | {D_{FGNT} + α_{GF} (D_{FGLT})} e^{-r}*^{τ} − _{$}P |
| _{$}V_{G+CB} + _{$}Intx_{MA, G} | P_{$} (RM + D_{DG})/(RER P_{LC}) |
| | {D_{FGNT} + α_{GF} (D_{FGLT})} e^{-r}*^{τ} − _{$}Put |

For all implicit options described here the Greek symbols (“greeks”) can be calculated as described in any standard options text such as fourth edition “Options, Futures and Other Derivatives” by John Hull. The main greeks are delta, gamma, rho, theta, vega and represent the option sensitivities. The greeks of the _{$}C (for G & MA) are gauges of nonlinearities and are used in the processes to determine changes and sensitivities of options as well as for early warning of crises, for constructing the values of derivative and securities to hedge or manage risk. Note how the delta, gamma and theta of the _{$}C are interrelated and market information can be used to infer the time to a crisis or regime shift.

Processes based on the Black-Scholes-Merton Equations to Value Contingent Claims on Assets of Government and Monetary Authorities and Sovereign Credit Risk

The disclosed technology can use all forms of processes for the estimation of the above equation and related equations set forth in this document. The disclosed processes include valuing of options and contingent claims using any type of method of calculating the options and contingent claims, including but not limited to Black-Scholes, Black-Scholes-Merton, European Option methods, American Option methods, binomial and other tree techniques, and other techniques.

1/e_{N,0}=(_{$}C+_{$}Intx_{MA,G})/(RM+D_{DG})

or equivalently,

1/e_{N,0}=_{$}C/(κRM+D_{DG})=P_{$}/(RER P_{LC})

1/e_{N,0}=1/exchange rate in LC/$ (or foreign currency FX) at time=0

In one embodiment, the relationships described previously can be used with the Black-Scholes or Black-Scholes-Merton closed form equations for options.

1/e_{N,0}=[(_{$}V_{G+CB,0}[N(d_{1GCBImV})]

−{D_{FGNT}+α_{GF}(D_{FGLT})}e^{-r*τ}[N(d_{2GCBImV})])+_{$}Intx_{MA,G}]/(RM+D_{DG})

d_{1GCBImV}=[1n((_{$}V_{G+CB,0})/{D_{FGNT}+α_{GF}(D_{FGLT})})

+(r*+_{$}σ²_{AGCB}/2)τ]/_{$}σ_{AGCB}τ^{½}

d_{2GCBImV}=d_{1GCBImV}−_{$}σ_{AGCB}τ^{½}

or equivalently,

1/e_{N,0}=[(_{$}V_{G+CB,0}[N(d_{1GCBImV})]

−{D_{FGNT}+α_{GF}(D_{FGLT})}e^{-r*τ}[N(d_{2GCBImV})])]/(κRM+D_{DG})

d_{1GCBImV}=[1n((_{$}V_{G+CB,0})/{D_{FGNT}+α_{GF}(D_{FGLT})})

+(r*+_{$}σ²_{AGCB}/2)τ]/_{$}σ_{AGCB}τ^{½}

d_{2GCBImV}=d_{1GCBImV}−_{$}σ_{AGCB}τ^{½}

ELL_{G&MA}=R+CY+D_{DG}=RM+D_{DG} and e_{N,0}=exchange rate in LC/$ or LC/FX and σ_{AGCB} is volatility of dollar of FX denominated assets _{$}V_{G+CB,0}. As per convention, N[ ] is the normal distribution as is used in the Black and Scholes formula. D_{FG} is foreign debt of the government and MA (near term (one year) and long term are broken out).

One widely used definition of the Real Exchange Rate is RER=e_{N,0} P_{$}/P_{LC}, or, RER P_{LC}/P_{$}=e_{N,0}

(RM+D_{DG})/e_{N,0}=P_{$}(RM+D_{DG})/(RER P_{LC})=

[(_{$}V_{G+CB,0}[N(d_{1GCBImV})]−{D_{FGNT}+α_{GF}(D_{FGLT})}e^{-r*τ}[N(d_{2GCBImV})])+_{$}Intx_{MA,G}]

or equivalently,

(κRM+D_{DG})/e_{N,0}=P_{$}(κRM+D_{DG})/(RER P_{LC})=

[(_{$}V_{G+CB,0}[N(d_{1GCBImV})]−{D_{FGNT}+α_{GF}(D_{FGLT})}e^{-r*τ}[N(d_{2GCBImV})])]

The disclosed technique can be used to evaluate risk and value chaiiges for sovereigns and countries that use a major hard currency, say US $, for their reserves as well as they frequently have foreign currency or $ denominated debt. The equations become:

(RM+D_{DG})/e_{N,0}=P_{$}(RM+D_{DG})/(RER P_{LC})=E_{$}[_{LC}V_{G+CB,0}] [N(d_{1GCBImV})]−

{D_{FGNT}+α_{GF}(D_{FGLT})}e^{-r*τ}[N(d_{2GCBImV})]+_{$}Intx_{MA,G}

or equivalently,

ti (κRM+D_{DG})/e_{N,0}=P_{$}(κRM+D_{DG})/(RER P_{LC})=E_{$}[_{LC}V_{G+CB,0}] [N(d_{1GCBImV})]

−{D_{FGNT}+α_{GF}(D_{FGLT})}e^{-r*τ}[N(d_{2GCBImV})]

E_{$}[_{LC}V_{G+CB}(0)]=(_{LC}V_{G+CB,0})/e_{N,0}

And,

_{$}σ_{AGCB}=(σ²_{AGCB}+σ²_{ER}−2ρ_{ER,ImV}σ_{ER}σ_{AGCB})^{½}

(RM+D_{DG})/e_{N,0}=P_{$}(RM+D_{DG})/(RER P_{LC})

=[_{LC}V_{G+CB,0}]/e_{N,0} [N(b_{1GCBImV})]

−{D_{FGNT}+α_{GF}(D_{FGLT})}e^{-r*τ}[N(b_{2GCBImV})]+_{$}Intx_{MA,G}

or equivalently,

(κRM+D_{DG})/e_{N,0}=P_{$}(κRM+D_{DG})/(RER P_{LC})

=[_{LC}V_{G+CB,0}]/e_{N,0} [N(b_{1GCBImV})]

−{D_{FGNT}+α_{GF}(D_{FGLT})}e^{-r*τ}[N(b_{2GCB1mV})]

b_{1GCBImV}=[1n((_{LC}V_{G+CB,0}/e_{N,0})/{D_{FGNT}+α_{GF}(D_{FGLT})})+(r*−q−2ρ_{ER,ImV}σ_{ER}

σ_{AGCB}+(σ²_{AGCB}+σ²ₑₙ)/2)τ]/(σ²_{AGCB}+σ²_{ER}−2ρ_{ER,ImV}σ_{ER}σ_{AGCB})τ^{½}

b_{2GCBImV}=b_{1GCBImV}−(σ²_{AGCB}+σ²_{ER}−2ρ_{ER,ImV}σ_{ER}σ_{AGCB})τ^{½}

For simplification lets define:

_{$}C=[_{LC}V_{G+CB,0}]/e_{N,0} [N(b_{1GCBImV})]

−{D_{FGNT}+α_{GF}(D_{FGLT})}e^{-r*τ}[N(b_{2GCBImV})]

_{$}C+_{$}Intx_{MA,G}=(RM+D_{DG})/e_{N,0}=P_{$}(RM+D_{DG})/(RER P_{LC})

_{$}C=(κRM+D_{DG})/e_{N,0}=P_{$}(κRM+D_{DG})/(RER P_{LC})

Macro Finance and Relationships from Put Call Parity

_{$}Call=_{$}Put−_{$}V_{G+CB,0}−{D_{FGNT}+α_{GF}(D_{FGLT})}e^{-r*τ}

_{$}Put=−[_{LC}V_{G+CB,0}]/e_{N,0} [N(−b_{1GCBImV})]

+{D_{FGNT}+α_{GF}(D_{FGLT})}e^{-r*τ}[N(−b_{2GCBImV})]

(RM+D_{DG})/e_{N,0}=P_{$}(RM+D_{DG})/(RER P_{LC})

=_{$}Put−_{$}V_{G+CB,0}−{D_{FGNT}+α_{GF}(D_{FGLT})}e^{-r*τ+}_{$}Intx_{MA,G}

_{$}V_{G+CB,0}={D_{FGNT}+α_{GF}(D_{FGLT})}e^{-r*τ}−_{$}Put−_{$}Intx_{MA,G}−(RM+D_{DG})/e_{N,0}

={D_{FGNT}+α_{GF}(D_{FGLT})}e^{-r*τ}−_{$}Put−Intx_{MA,G}−P_{$}(RM+D_{DG})/(RER P_{LC})

or

P_{LC}=P_{$}(RM+D_{DG})/[RER{_{$}Put+_{$}Intx_{MA,G}−_{$}V_{G+CB,0}

−{D_{FGNT}+α_{GF}(D_{FGLT})}e^{-r*τ}}]

Choice of Asset _{$}V_{G+CB}

_{$}V_{G+CB}=_{LC}V_{G+CB,0}/e_{N,0}

=[NFA_{MA}+IMF/CCL+λDA/e_{N,0}

DA={NG_{Rev}+ΔNG_{Rev})−ΣⱼP_{Bj}+ΣⱼFSCEO_{Bj}+ΣⱼD_{Bj}}]

NG_{Rev}+ΔNG_{Rev}=PD_{G,1}+q₁D_{D,t-1}+PD_{G,2}++q₂D_{D,t}+CD_{AVE}/r_{CD}+ΔNG_{Rev}

Macro Financial Balance Sheet

The equilibrium relationships based on option and contingent claims pricing in this disclosure produce balance sheet formulation for the government and monetary authorities, as described below.

| Assets | Liabilities |
|---|---|
| Asset value of Government and | “Equity Like Liabilities” = Call Option |
| Monetary Authorities | Market Value of Real Debt ( FX or |
| | indexed debt) Default Barrier |
| _{$}V_{G+CB} + _{$}Intx_{MA, G} | (RM + D_{DG})/e_{N, 0} = _{$}C = Call Option |
| | {D_{FGNT} + α_{GF} (D_{FGLT})} e^{-r}*^{τ} − _{$}P |
| NFA_{MA} | |
| (+IMF/CCL) | [_{LC}V_{G+CB, 0}]/e_{N, 0} [N(b_{1GCBImV})] |
| | −{D_{FGNT} + α_{GF} (D_{FGLT})} |
| +λ DA/e_{N, 0} | e^{r}*^{τ}[N(b_{2GCBImV})] |
| +_{$}Intx_{MA, G} | + |
| | {D_{FGNT} + α_{GF}(D_{FGLT})} e^{-r}*^{τ} − |
| | _{LC}ImV_{G+CB, 0}/e_{N, 0} [N(−b_{1GCBImV})] |
| | +{D_{FGNT} + α_{GF}(D_{FGLT})} |
| | e^{-r}*^{τ}[N(−b_{2GCBImV})] |

Macro Financial Risk Model—Main Formulas

Corporate & Household Sectors

EQ_{c,1}=V_{Ac,1}−(D_{c,i}+D_{Fc,1}e_{N})+P_{Tc,1}

EQ_{c,1}=V_{Ac,i}[N(d₁)]−(D_{c,1}+D_{Fc,1}e_{N})e^{-rt}[N(d₂)]

σ_{E,1}=N(d₁)V_{Ac,10}σ_{A}/E_{c,10}

EQ_{c,1}=V_{Ac,1}−(D_{c,i}+D_{Fc,1}e_{N}−P_{Tc,1})

Banking and Financial Institution Sectors

EQ_{Bj}=Σ₁sⱼ₁E_{c,1}−Σ₁sⱼ₁P_{c,i}+NFA_{Bj}+FSCEO_{Bj}+Intx_{B}

−(Dep_{Bj}+DC_{Bj}+D_{FBj}e_{N})+P_{Bj}+P_{FBj}

EQ_{Bj}=(Σ₁sⱼ₁D_{c,i}−Σ₁sⱼ₁P_{c,1}+NFA_{Bj}e_{N}+CR_{Bj}+Intx_{B})[N(d_{1Bj})]

−(Dep_{Bj}+DC_{Bj}+D_{FBj}e_{N})e^{-rt}[N(d_{2Bj})]

σ_{EBj}=N(d_{1Bj})V_{Bj}σ_{ABj}/E_{Bj}

V_{Bj}=Σ₁sⱼᵢD_{c,1}−Σ₁sⱼᵢP_{c,1}+NFA_{Bj}e_{N}+CR_{Bj}+FSCEO_{Bj}+Intx_{B}

+P_{Bj}+P_{FBj}

Government & Monetary Authorities

(RM+D_{DG})/e_{N,0}

=P_{$}(RM+D_{DG})/(RER P_{LC})

=[_{LC}V_{G+CB,0}]/e_{N,0} [N(b_{1GCBImV})]

−{D_{FGNT}+α_{GF}(D_{FGLT}(}e^{-r*τ}[N(b_{2GCBImV})]+_{$}Intx_{MA,G}

or equivalently,

(κRM+D_{DG})/e_{N,0}

=P_{$}(κRM+D_{DG})/(RER P_{LC})

=[LCV_{G+CB,0}]/e_{N,0} [N(b_{1GCBImV})]

−{D_{FGNT}+α_{GF}(D_{FGLT})}e^{-r*τ}[N(b_{2GCBImV})]

b_{1GCBImV}=[1n(_{LC}V_{G+CB,0}/e_{N,0})/{D_{FGNT}+α_{GF}(D_{FGLT})})+(r*−q−2ρ_{ER,ImV}σ_{ER}

σ_{AGCB}+(σ²_{AGCB}+σ²ₑₙ)/2)τ]/(σ²_{AGCB}+σ²_{ER}−2 ρ_{ER,ImV}σ_{ER}σ_{AGCB})τ^{½}

b_{2GCBImV}=b_{1GCBImV}−(σ²_{AGCB}+σ²_{ER}−2ρ_{ER,ImV}σ_{ER}σ_{AGCB})τ^{½}

Calibrating the Government and Monetary Authority Macro Financial Risk Model for an Economy—Process with One Combined Asset Government and Monetary Authority

Calibration means using macroeconomic and financial information on the value of equity and its volatility, the default barrier data, certain asset related characteristics and other parameters to estimate the implied asset value and its volatility. This model, once calibrated can be used for all kinds of sensitivity tests, simulations, forward projections and analysis of value changes and equilibrium adjustments. The specific approach depends on data and the type of structure of the economy, so somewhat different combinations of formulas and unknowns can be used for calibration.

Process A:

This process uses a formulation with one combined asset for the government and monetary authorities _{$}ImV_{G+CB,0}. Three equations and three unknowns: _{$}ImV_{G+CB,0} (implied asset value of G and MA), _{$}σ_{AGCB} (volatility of assets of G and MA), σ_{AGCB} asset volatiltiy in local currency. The unknowns can be estimated from the following three equations:

Equation A1:

(RM+D_{DG})/e_{N,0}=P_{$}(RM+D_{DG})/(RER P_{LC})=

_{$}ImV_{G+CB,0}[N(b_{1GCBImV})]−{D_{FGNT}+α_{GF}(D_{FGLT})}e^{-r*τ}[N(b_{2GCBImV})]+_{$}Intx_{MA,G}

Equation A2:

_{$}σ_{FXELL/}e_{N,0}=N(b_{1GCBImV})_{$}ImV_{G+CB,0} _{$}σ_{AGCB}/[(RM+D_{DG})₀/e_{N,0}]

Equation A3:

_{$}σ_{AGCB}=(σ²_{AGCB}+σ²_{ER}−2ρ_{ER,ImV} σ_{ER} σ_{AGCB})^{½}

where,

b_{1GCBImV}=[1n(_{LC}V_{G+CB,0}/e_{N,0})/{D_{FGNT}+α_{GF})})+(r*−q−2ρ_{ER,ImV} σ_{ER}

σ_{AGCB}+(σ²_{AGCB}+σ²ₑₙ)/2)τ]/(σ²_{AGCB}+σ²_{ER}−2 ρ_{ER,ImV} σ_{ER} σ_{AGCB})τ^{½}

b_{2GCBImV}=b_{1GCBImV}−(σ²_{AGCB}+σ²_{ER}−2 ρ_{ER,ImV} σ_{ER} σ_{AGCB})τ^{½}

ρ_{ER,ImV}=derived from simulations of fiscal revenues, including financial sector put option

_{$}ImV_{G+CB,0}=[*NFA_{MA}e_{N,0}+λDA]/e_{N,0}

λ=1

where,

_{LC}ImV_{G+CB,0}≡*NFA_{MA}e_{N,0}+λDA

=[NFA_{MA}e_{N,0}+IMF/CCL e_{N,0}

+λ{NG_{Rev}+ΔNG_{Rev}−ΣⱼP_{Bj}−ΣⱼFSCEO_{Bj}+ΣⱼDC_{Bj}}]

and,

σ_{FXELL}=σ_{FXELLmeasured}[(D_{DG,t}+RMₜ))/e_{N,t}]/[(D_{DG,t}+RMₜ+MTV))/e_{N,t}]=

volatility of FXELL due to the equity value only.

Process AI:

This process uses a formulation with one combined asset for the government and monetary authorities _{$}ImV_{G+cB,0} Three equations (AI 1, AI 2, and AI 3) and three unknowns: _{$}ImV_{G+CB,0} (implied asset value of G and MA), _{$}σ_{AGCB} (volatility of assets of G and MA), σ_{AGCB} asset volatility in local currency. The unknowns are estimated from the following three equations:

Equation AI 1:

(κRM+D_{DG}+D_{DG})/e_{N,0}=P_{$}(κRM+D_{DG})/(RER P_{LC})=

_{$}ImV_{G+CB,0}[N(b_{1GCBImV})]−{D_{FGNT}+α_{GF}(D_{FGLT})}e^{-r*τ}[N(b_{2GCBImV})]

Equation AI 2:

_{$}σ_{FXELL}=N(b_{1GCBImV})_{$}ImV_{G+CB,0} _{$}σ_{AGCB}/[κRM+D_{DG})₀/e_{N,0}]

Equation AI 3:

_{$}σ_{AGCB}=(σ²_{AGCB}+Σ²_{ER}−2 ρ_{ER,ImV} σ_{ER} σ_{AGCB})^{½}

where,

b_{1GCBImV}=[1n((_{LC}V_{G+CB,0}/e_{N,0})/{D_{FGNT}+α_{GF}(D_{FGLT})})+(r*−q−2ρ_{ER,ImV} σ_{ER}

σ_{AGCB}+(σ²_{AGCB}+σ²ₑₙ)/2)τ]/(σ²_{AGCB}+σ²_{ER}−2 ρ_{ER,ImV} σ_{ER} σ_{AGCB})τ^{½}

b_{2GCBImV}=b_{1GCBImV}−(σ²_{AGCB}+σ²_{ER}−2 ρ_{ER,ImV} σ_{ER} σ_{AGCB})τ^{½}

ρ_{ER,ImV}=derived from simulations of fiscal revenues, including financial sector put option

_{$}ImV_{G+CB,0}=[*NFA_{MA}e_{N,0}+λDA]/e_{N,0}

Process AII:

This process uses a formulation with one combined asset for the government and monetary authorities _{$}ImV_{G+CB,0}. Two equations and two unknowns: _{$}ImV_{G+CB,0} (implied asset value of G and MA), _{$}σ_{AGCB} (volatility of assets of G and MA). The unknowns are estimated from the following three equations:

Equation AII 1:

(κRM+D_{DG})/e_{N,0}=P_{$}(κRM+D_{DG})/(RER P_{LC})=

_{$}ImV_{G+CB,0}[N(b_{1GCBImV})]−{D_{FGNT}T30 α_{GF}(D_{FGLT})}e^{-r*τ}[N(b_{2GCBImV})]

Equation AII 2:

_{$}σ_{FXELL}=N(b_{1GCBImV})_{$}ImV_{G+CB,0} _{$}σ_{AGCB}/[(κkRM+D_{DG})₀/e_{N,0}]

Equation AII 3:

_{$}σ_{FXELL}=(σ²_{ELL}+σ²_{ER}−2 ρ_{ER,ELL} σ_{ER} σ_{ELL})^{½}

where,

b_{1GCBImV}=[1n((_{LC}V_{G+CB,0}/e_{N,0})/{D_{FGNT}+α_{GF}(D_{FGLT})})+(r*+_{$}σ²_{AGCB}/2)τ]/

(_{$}σ_{AGCB})τ^{½}

b_{2GCBImV}=b_{1GCBImV}−(_{$}σ_{AGCB})τ^{½}

σ_{FXELL}=volatility of ELL (κRM+D_{DG}) in local currency

Process B: 711 This process uses a formulation with one combined asset for the government and monetary authorities _{$}ImV_{G+CB,0} Four equations and four unknowns: _{$}ImV_{G+CB,0} (implied asset value of G and MA), _{$}σ_{AGCB} (volatility of assets of G and MA), (σ_{AGCB} asset volatility in local currency, λ lambda adjustment factor for uncertainty in level of DA, and skew, and/or MTV. The unknowns can be estimated from the following four equations:

Equation B1:

(RM+D_{DG})/e_{N,0}=P_{$}(RM+D_{DG})/(RER P_{LC})=

_{$}ImV_{G+CB,0}[N(b_{1GCBImV})]−{D_{FGNT}+α_{GF}(D_{FGLT})}e^{-r*τ}[N(b_{2GCBImV})]+_{$}Intx_{MA,G}

Equation B2:

σ_{FXELL/}e_{N,0}=N(b_{1GCBImV})_{$}ImV_{G+CB,0} _{$}σ_{AGCB}/[RM+D_{DG})₀/e_{N,0}]

Equation B3:

(D_{FGNT}+α_{GF}(D_{FGLT}))/(1+r*)−(D_{FGNT}+α_{GF}(D_{FGLT}))/(1+r*+s_{SOVFX})

={D_{FGNT}+α_{GF}(D_{FGLT})}e^{-r*τ}[N(−b_{2GCBImV})]

−(_{$}ImV_{G+CB,0}) [N(−b_{1GCBImV})]

Equation B4:

_{$}σ_{AGCB}=(σ²_{AGCB}+σ²_{ER}−2 ρ_{ER,ImV} σ_{ER} σ_{AGCB})^{½}

_{$}ImV_{G+CB,0}=[*NFA_{MA}e_{N,0}+λDA]/e_{N,0}

where,

_{LC}ImV_{G+CB,0}≡*NFA_{MA}e_{N,0}+λDA

=[NFA_{MA}e_{N,0}+IMF/CCL e_{N,0}

+λ{NG_{Rev}+ΔNG_{Rev}−ΣⱼP_{Bj}−ΣⱼFSCEO_{Bj}+ΣⱼDC_{Bj}}]

and,

σ_{FXELL}=σ_{FXELLmeasured}[(D_{DG,t}+RMₜ))/e_{N,t}]/[(D_{DG,t}+RMₜ+MTV))/e_{N,t}]=

volatility of FXELL due to the equity value only.

s_{SOVFX} is sovereign spread

Process BI:

This process uses a formulation with one combined asset for the government and monetary authorities _{$}ImV_{G+CB,0}. Two equations (BI 1 and BI 2)and two unknowns: _{$}ImV_{G+CB,0} (implied asset value of G and MA), _{$}σ_{AGCB} (volatility of assets of G and MA). The unknowns can be estimated from the following three equations:

Equation BI 1:

(κRM+D_{DG})/e_{N,0}=P_{$}(κRM+D_{DG})/(RER P_{LC})=

_{$}ImV_{G+CB,0}[N(b_{1GCBImV})]−{D_{FGNT}+α_{GF}(D_{FGLT})}e^{-r*τ}[N(b_{2GCBImV})]

Equation BI 2:

_{$}σ_{FXELL}=N(b_{1GCBImV})_{$}ImV_{G+CB,0} _{$}σ_{AGCB}/[(κRM+D_{DG})₀/e_{N,0}]

Equation BI 3:

_{$}σ_{FXELL}=(σ²_{ELL}+σ²_{ER}−2 ρ_{ER,ELL} σ_{ER} σ_{ELL})^{½}

where,

b_{1GCBImV}=[1n((_{LC}V_{G+CB,0}e_{N,0})/{D_{FGNT}+α_{GF})})+(r*+_{$}σ²_{AGCB}/2)τ]/

(_{$}σ_{AGCB})τ^{½}

b_{2GCBImV}=b_{1GCBImV}−(_{$}σ_{AGCB})τ^{½}

σ_{FXELL}=volatility of ELL (κRM+D_{DG}) in local currency

Equation BI 4:

(D_{FGNT}+α_{GF}(D_{FGLT}))/(1+r*)−(D_{FGNT}+α_{GF}(D_{FGLT}))/(1+r*+s_{SOVFX})

={D_{FGNT}+α_{GF}(D_{FGLT})}e^{-r*τ}[N(−b_{2GCBImV})]

−(_{$}ImV_{G+CB,0}) [N(−b_{1GCBImV})]

which is equivalent to,

s_{SOVFX}=(−1/τ) 1n [N(−b_{2GCBImV})−(N(−b_{1GCBImV}))(_{LC}V_{G+CB,0}/e_{N,0})/({D_{FGNT}+α_{GF}(D_{FGLT})})]

and using the equations below,

For floating exchange rate: 1/e_{N,τ}=(1/e_{N,0})e^{(r*-r-risk premium)τ}

For fixed exchange rate: 1/e_{N,τ}=(1/e_{N,0}), so

For a floating exchange rate then,

1/e_{N,0}={e^{(-r*+r+risk premium)τ}(1/e_{N,τ})}, so

Equation BI 5:

(κRM+D_{DG})/{e^{(-r*+r+risk premium)τ}(1/e_{N,τ})}

=P_{$}(κRM+D_{DG})/(RER P_{LC})/{e (−r*+r+risk premium)τ(1/e_{N,τ})}

=_{$}ImV_{G+CB,0}[N(b_{1GCBImV})]−{D_{FGNT}+α_{GF}(D_{FGLT})}e^{-r*τ}[N(b_{2GCBImV})]

Equation BI 6: Same as BI 5 except any default barrier DB={D_{FGNT}+α_{GF}(D_{FGLT})}

where,

_{LC}ImV_{G+CB,0}≡*NFA_{MA}e_{N,0}+λDA

=[NFA_{MA}e_{N,0}+IMF/CCL e_{N,0}

+λ{NG_{Rev}+ΔNG_{Rev}−ΣⱼP_{Bj}−ΣⱼFSCEO_{Bj}+ΣⱼDC_{Bj}}]

This process thus interrelates all the variables together in an “equilibrium” equations for the economy.

Process BII

This process uses a formulation with one combined asset for the government and monetary authorities _{$}ImV_{G+CB,0} It includes three (or more layers of liabilities), the most junior (κRM+D_{DG})/e_{N,0}, the next most junior or subordinated debt (D_{DSubG})/e_{N,0}, the most senior (D_{SrG)/e}_{N,0} Two equations (B II 1 and B II 2) and two unknowns: _{$}ImV_{G+CB,0} (implied asset value of G and MA), _{$}σ_{AGCB} (volatility of assets of G and MA). The unknowns are estimated from the following equations:

Equation BII 1:

(κRM+D_{DG})/e_{N,0}=P_{$}(κRM+D_{DG})/(RER P_{LC})=

_{$}ImV_{G+CB 0[N(b}_{1ImVSr&Sub})]−{D_{FGNT}+α_{GF}(D_{FGLT})}e^{r*τ}[N(b_{2ImVSr&Sub})]

Equation BII 2:

_{$}σ_{FXELL}=N(b_{1ImVSr&Sub})_{$}ImV_{G+CB,0} _{$}σ_{AGCB}/[κRM+D_{DG})₀/e_{N,0}]

Equation BII 3:

_{$}σ_{FXELL}=(σ²_{ELL}+σ²_{ER}−2 ρ_{ER,ELL} σ_{ER} σ_{ELL})^{½}

Equation BII 4:

D_{Sub}e^{-r*τ}=_{$}ImV_{G+CB,0}[N(b_{1ImVSr)]-{D}_{FGNT}+α_{GF}(D_{FGLT})}e^{-r*τ}[N(b_{2ImVSr})]−

_{$}ImV_{G+CB,0}[N(b_{1ImVSr&Sub})]+{D_{FGNT}+α_{GF}(D_{FGLT})}e^{-r*τ}[N(b_{2ImVSr&Sub})]

where,

b_{1ImVSr&Sub}=[1n((_{LC}V_{G+CB,0}/e_{N,0})/{D_{FGNT}+α_{GF}(D_{FGLT}+D_{Sub})})+(r*+_{$}σ²_{AGCB}/2)

τ]/(_{$}σ_{AGCB})τ^{½}

b_{2ImVSr&Sub}=b_{1mVSr&Sub}−(_{$}σ_{AGCB})τ^{½}

b_{1ImVSr}=[1n((_{LC}V_{G+CB,0}/e_{N,0})/{D_{FGNT}+α_{GF}(D_{FGLT})})+(r*+_{$}σ²_{AGCB}/2)τ]/

(_{$}σ_{AGCB})τ^{½}

b_{2ImVSr}=b_{1mVSr}−(_{$}σ_{AGCB})τ^{½}

σ_{FXELL}=volatility of ELL (κRM+D_{DG}) in local currency

Equation BII 5:

D_{sub}e^{-r*τ}_{$}σ_{Sub}=[N(b_{1ImVSr})−N(b_{1ImVSr&Sub})]_{$}ImV_{G+CB,0} _{$}σ_{AGCB}

Where D_{Sub} is subordinated debt=_{LC}D_{Sub}/e_{N,τ}

Equation BII 6:

(D_{FGNT}+α_{GF}(D_{FGLT}))/(1+r*)−(D_{FGNT}+α_{GF}(D_{FGLT}))/(1+r*+s_{SOVFX})

={D_{FGNT}+α_{GF}(D_{FGLT})}e^{-r*τ}[N(−b_{2GCBImV})]

−(_{$}ImV_{G+CB,0}) [N(−b_{1GCBImV})]

which is equivalent to,

s_{SOVFX}=(−1/τ)1n[N(−b_{2ImVSr})−(N(−b_{1ImVSr))(}_{LC}V_{G+CB,0}/e_{N,0})/({D_{FGNT}+α_{GF}(D_{FGLT})})]

and using the following equations from section 10 (below),

For floating exchange rate: 1/e_{N,τ}=(1/e_{N,0})e^{(r*-r-risk premium)τ}

For fixed exchange rate: 1/e_{N,τ}=(1/e_{N,0}), so

For a floating exchange rate then,

1/e_{N,0}={e^{(-r*+r+risk premium)τ}(1/e_{N,τ})},

the forward exchange rate F=e_{N,0}e^{(-r*+r+risk premium)τ}

so F=e_{N,0}e^{(-r*+r+risk premium)τ}=P_{$}/(RER P_{LC})

Equation BII 7:

(κRM+D_{DG})/{e^{(-r*+r+risk premium)τ}(1/e_{N,τ})}

=P_{$}(κRM+D_{DG})/(RER P_{LC})

=_{$}ImV_{G+CB,0}[N(b_{1GCBImV})]−{D_{FGNT}+α_{GF}(D_{FGLT})}e^{-r*τ}[N(b_{2GCBImV})]

Equation BII 8: Same as BI 5 except any default barrier DB={D_{FGNT}+α_{GF}(D_{FGLT})}

where,

_{LC}ImV_{G+CB,0}≡*NFA_{MA}e_{N,0}+λDA

=[NFA_{MA}e_{N,0}+IMF/CCL e_{N,0}

+λ{NG_{Rev}+ΔNG_{Rev}−ΣⱼP_{Bj}−ΣⱼFSCEO_{Bj}+ΣⱼDC_{Bj}}]

This process thus interrelates all the variables together in an “equilibrium” equations for the economy.

Process C:

This process uses a formulation with one combined asset for the government and monetary authorities _{$}ImV_{G+CB,0}. Four equations and four unlknowns: _{$}ImV_{G+CB,0} (implied asset value of G and MA), _{$}σ_{AGCB} (volatility of assets of G and MA), σ_{AGCB} asset volatility in local currency, α_{GF} debt parameter in default barrier. These equations may be important if external debt issues are particularly important and helps calibrate in the presence of fat-tails. The unknowns are estimated from the following four equations:

Equation C1:

(RM+D_{DG})/e_{N,0}=P_{$}(RM+D_{DG})/(RER P_{LC})=

_{$}ImV_{G+CB,0}[N(b_{1GCBImV})]−{D_{FGNT}+α_{GF}(D_{FGLT})}e^{-r*τ}[N(b_{2GCBImV})]+_{$}Intx_{MA,G}

Equation C2:

σ_{FXELL/}e_{N,0}=N(b_{1GCBImV}) _{$}ImV_{G+CB,0} _{$}σ_{AGCB}/[(RM+D_{DG})₀/e_{N,0}]

Equation C3:

(D_{FGNT}+α_{GF}(D_{FGLT}))/(1+r*)−(D_{FGNT}+α_{GF}(D_{FGLT}))/(1+r*+s_{SOVFX})

={D_{FGNT}+α_{GF}(D_{FGLT})}e^{-r*τ}[N(−b_{2GCBImV})]

−(_{$}ImV_{G+CB,0}) [N(−b_{1GCBImV})]

Equation C4:

_{$}σ_{AGCB}=(σ_{2AGCB}+σ²_{ER}−2 ρ_{ER,ImV} σ_{ER} σ_{AGCB})^{½}

_{$}ImV_{G+CB,0}=[*NFA_{MA}e_{N,0}+λDA]/e_{N,0}

ρ_{ERImV}=derived from simulations of fiscal revenues, including financial sector put option

λ=1

where,

_{LC}ImV_{G+CB,0}≡*NFA_{MA}e_{N,0}+λDA

=[NFA_{MA}e_{N,0}+IMF/CCL e_{N,0}

+λ{NG_{Rev}+ΔNG_{Rev}−Σ_{Bj}−P_{Bj}−ΣⱼFSCEO_{Bj}+ΣⱼDC_{Bj}}]

and,

σ_{FXELL}=σ_{FXELLmeasured}[D_{DG,t}+RMₜ))/e_{N,t}]/[(D_{DG,t}+RMₜ+MTV))/e_{N,t}]=

volatility of FXELL due to the equity value only.

s_{SOVFX} is observed sovereign spread

Process D:

This process uses a formulation with one combined asset for the government and monetary authorities _{$}ImV_{G+CB,0}. Four equations and four unknowns: _{$}ImV_{G+CB,0} (implied asset value of G and MA), _{$}σ_{AGCB} (volatility of assets of G and MA), σ_{AGCB} asset volatility in local currency, t or time. These equations may be important if crisis is very close. The unknowns are estimated from the following four equations:

Equation D1:

(RM+D_{DG})/e_{N,0}=P_{$}(RM+D_{DG})/(RER P_{LC})=

_{$}ImV_{G+CB,0} N(b_{1GCBImV})−{D_{FGNT}+α_{GF}(D_{FGLT})}e^{-r*τ}[N(b_{2GCBImV})]+_{$}Intx_{MA,G}

Equation D2:

σ_{FXELL/}e_{N,0}=N(b_{1GCBImV})_{$}ImV_{G+CB,0} _{$}σ_{AGCB}/[(RM+D_{DG})₀/e_{N,0}]

Equation D3:

(D_{FGNT}+α_{GF}(D_{FGLT}))/(1+r*)−(D_{FGNT}+α_{GF}(D_{FGLT}))/(1+r*+s_{SOVFX})

={D_{FGNT}+α_{GF}(D_{FGLT})}e^{-r*τ}[N(−b_{2GCBlmV})]

−(_{$}ImV_{G+CB,0}) [N(−b_{1GCBImV})]

Equation D4:

_{$}σ_{AGCB}=(σ²_{AGCB}+σ²_{ER}−2 σ_{ER} σ_{AGCB})^{½}

where,

_{$}ImV_{G+CB,0}=[*NFA_{MA}e_{N,0}+λDA]/e_{N,0}

ρ_{ER,ImV}=derived from simulations of fiscal revenues, including financial sector put option

λ=1

where,

_{LC}ImV_{G+CB,0}≡*NFA_{MA}e_{N,0}+λDA

=[NFA_{MA}e_{N,0}+IMF/CCL e_{N,0}

+λ{NG_{Rev}+ΔNG_{Rev}−ΣⱼP_{Bj}−ΣⱼFSCEO_{Bj}+ΣⱼDC_{Bj}}]

and,

σ_{FXELL}=σ_{FXELLmeasured}[(D_{DG,t}+RMₜ))/e_{N,t}]/[(D_{DG,t}+RMₜ+MTV))/e_{N,t}]=

volatility of FXELL due to the equity value only.

s_{SOVFX} is observed sovereign spread

Calibrating the Government and Monetary Authority Macro Financial Risk Model for an Economy—Process with Two Distinct Assets for the Government and Monetary Authority

In the situation where there is significant variability in the foreign exchange denominated assets and volatility in the fiscal domestic assets, the model can have two assets, one is the stochastic net foreign assets and the other is the stochastic domestic fiscal asset. In an embodiment with two assets, an option formula can be used. This can be done with many different methods and the disclosed technique can be used with all various option calculation methods. If, for example, a Black-Scholes-Merton formulation is used, then the following two asset formulas and Ito's lemma are used:

Call on max of two risky assets=max (S₁, S₂, X)−X=

S₁ exp(−δ₁T) {N[w₃]−N₂[−w₁; w₃; ρ₁]}

+S₂ exp(−δ₂T) {N[w₄]−N₂[−w₂; w₄; ρ₂]}

+X exp(−r T) N₂[−w₁+σ₁T^{½}; −w₂+σ₂T^{½}; ρ₁₂]

−X exp(−r T)

where,

S₁=value of asset 1

S₂=value of asset 2

X=value of default barrier or strike price

Σ=(σ₁²+σ₂²−2 ρ₁₂ σ₁ σ₂)^{½}

ρ₁=(ρ₁₂ σ₂−σ₁)/Σ

w₁={1n(S₁/X)+(r−δ₁+0.5σ₁²)T}/σ₁T^{½}

w₂={1n(S₂/X)+(r−δ₂+0.5σ₂²)T}/σ₂T^{½}

w₃={1n(S₁/S₂)+(δ₂−δ₁+0.5Σ²)T}/ΣT^{½}

w₄={1n(S₂/S₁)+(δ₁−δ₂+0.5Σ²)T}/ΣT^{½}

δ₁=dividend for asset 1

δ₂=dividend for asset 2

ρ₁₂=correlation of asset 1 and 2

σ₁=volatility of asset 1

σ₂=volatility of asset 2

Two asset Ito's Lemma:

σ_{E}E=(∂E/∂S₁)S₁σ₁+(∂E/∂S₂)S₂σ₂+(∂²E/∂S₁∂S₂)S₁σ₁S₂σ₂ρ₁₂

σ_{E}E={N[w₃]−N₂[−w₁; w₃; ρ₁]}S₁σ₁+{N[w₄]−N₂[−w₂; w₄; ρ₂]}S₂σ₂

+N₂[−w₁+σ₁T^{½}; −w₂+σ₂T^{½}; ρ₁₂]S₁σ₁S₂σ₂ρ₁₂

E=equity or contingent claim value, σ_{E}=volatility of equity

N₂ [ ]=bivariate normal distribution

Process E:

This process uses a formulation with two assets for the government and monetary authorities *NFA_{MA}, _{$}ImDAV. Four equations and four unknowns: _{$}ImDAV (implied asset value of G), σ_{AG} asset volatility in local currency (implied volatility of _{$}σ₂ in foreign currency terms of assets of G are estimated first but this is linked via equation 3 so that σ_{AG} can be estimated), t or time (or the fourth unknown can be α_{GF} or ρ₂ or other). The unknowns are estimated from the following four equations (or first three equations if there are three key unknowns):

Equation E1:

Call on max of two risky assets with default barrier of X={D_{FGNT}+α_{GF}(D_{GLT})}

=max (*NFA_{MA}, _{$}ImDAV, X)−X=

(RM−Intx_{MA,G}+D_{DG})/e_{N,0}P_{$}(RM−Intx_{MA,G}+D_{DG})/(RER P_{LC})

=*NFA_{MA}exp(−δ₁T) {N[w₃]−N₂[−w₁; w₃; ρ₁]}

+_{$}ImDAV exp(−δ₂T) {N[w₄]−N₂[−w₂; w₄; ρ₂]}

+{D_{FGNT}+α_{GF}(D_{FGLT})}exp(−r* T) N₂ [−w₁+σ₁T^{½}; −w₂+σ₂T^{½}; ρ₁₂]

−{D_{FGNT}+α_{GF}(D_{FGLT})}exp(−r* T)≡_{$}C_{TwoAsset}

Equation E2:

Two asset Ito's Lemma:

σ_{E}E=(∂E/∂S₁)S₁σ₁+(∂E/∂S₂)S₂σ₂+(∂²E/∂S₁∂S₂)S₁σ₁S₂σ₂ ρ₁₂

σ_{E}(RM−_{$}Intx_{MA,G}+D_{DG})/e_{N,0}={N[w₃]−N₂[−w₁; w₃; ρ₁]}*NFA_{MA} σ₁

+{N[w₄]−N₂[−w₂; w₄; ρ₂]}_{$}ImDAV σ₂

+N₂[−w₁+σ₁T^{½}; −w₂+σ₂T^{½}; ρ₁₂]*NFA_{MA}σ₁_{$}ImDAV σ₂ ρ₁₂

Equation E3:

σ₂=(σ²_{AG}+σ²_{ER}−2 ρ_{ER,ImV} σ_{ER} σ_{AG})^{½}

Equation E4:

(D_{FGNT}+α_{GF}(D_{FGLT}))/(1+r*)−(D_{FGNT}+α_{GF}(D_{FGNT}+α_{GF}(D_{FGLT}))/(1+r*+s_{SOVFX})

=PUT=_{$}C_{TwoAsset}−(N*NFA_{MA}+_{$}ImDAV)−{D_{FGNT}+α_{GF}(D_{FGLT})}e^{-r*τ}

ρ_{ER,ImV}=derived from simulations of fiscal revenues, including financial sector put option

Where,

_{$}ImDAV=λDA/e_{N,0}

*NFA_{MA}=NFA_{MA}+IMF/CCL

_{$}ImDAV+*NFA_{MA}=[NFA_{MA}e_{N,0}+IMF/CCL e_{N,0}

+λ{NG_{Rev}+ΔNG_{Rev}−ΣⱼP_{Bj}−ΣⱼFSCEO_{Bj}+ΣⱼDC_{Bj}}]/e_{N,0}

Σ=(σ₁²+σ₂²−2 ρ₁₂ σ₁ σ₂)^{½}

ρ₁=(ρ₁₂ σ₂−σ₁)/Σ

ρ₂=(ρ₁₂ σ₁−σ₂)/Σ

w₁={1n (*NFA_{MA}/{D_{FGNT}+α_{GF}(D_{FGLT})})+(r−δ₁+0.5σ₁²)T}/σ₁T^{½}

w₂={1n (_{$}Im_{DAV}/{D_{FGNT}+α_{GF}(D_{FGLT})})+(r−δ₂+0.5σ₂²)T}/σ₂T^{½}

w₃={1n (*NFA_{MA}/_{$}ImDAV )+(δ₂−δ₁+0.5Σ²)T}/ΣT^{½}

w₄={1n (_{$}Im_{DAV}/*NFA_{MA})+(δ₁−δ₂+0.5Σ²)T}/ΣT^{½}

δ₁=dividend for asset 1, in this case for NFA is 0 or earning the r*, so=−r*

δ₂=dividend for asset 2, in this case for ImDAV, is close to r or q the dividend paid from the fiscal asset related to domestic debt.

Process F:

This process uses a formulation with one combined asset for the government and monetary authorities _{$}IMV_{G+CB,0}. Three equations and three unknowns: _{$}ImV_{G+CB,0} (implied asset value of G and MA), _{$}σ_{AGCB} (volatility of assets of G and MA), σ_{AGCB} asset volatility in local currency. The skew “s” and kurtosis “k” of the asset value of G and MA as well as the volatility of the asset σ_{AGCB} can define the moments of the distribution. The unknowns _{$}ImV_{G+CB,O}, s, k, σ_{AGCB} can be estimated from the following equations:

Equation F1:

(RM+D_{DG})/e_{N,0}=P_{$}(RM+D_{DG})/(RER P_{LC})=

_{$}ImV_{G+CB,0}[N(b_{1GCBImV})]−{D_{FGNT}+α_{GF}(D_{FGLT})}e^{-r*τ}[N(b_{2GCBImV})]+_{$}Intx_{MA,G}

Other equations (parametric and non-parameteric) can estimate the unknowns using information from the similes of foreign currency options, from any equity or junior claim, from one or more multiple layers of liabilities, and/or from any combination thereof.

Process G:

This process can include one or more of the previously described processes, where the local currency operations of the monetary authorities are separated from the accounts of the government and monetary authorities, resulting in a balance sheet that includes the government plus foreign currency liabilities of the monetary authorities. In this case, there is a new junior liability on the government plus foreign currency liabilities of the monetary authorities—that of the loans to the government from the monetary authorities plus the monetary authority's holding of government securities. The loans/credit to the government and holdings of government securities can be provided by the central bank by the creation of high powered money, i.e., by the central bank writing a check against itself. The credit risk to the central bank is relatively high as the government does not have to, and usually does not, pay the central bank back. Although this represents a risky, junior claim, it does not cause financial distress to the central bank because it can always create more high powered money (it requires no financial guarantee from the government).

Interlinked MFR formulas with Money Demand, Inflation, Exchange Rate Regime, Real Exchange Rate and Current Account and Interest Parity

The formulas for the call option on Government and Monetary Authority assets, either the one asset formulation _{$}C or the two asset formulation _{$}C_{TwoAsset}, called _{$}C here for simplification, can be applied to form the follow relationships:

1/e_{N}=(_{$}C+_{$}Intx_{MA,G})/(RM+D_{DG})

_{$}C+_{$}Intx_{MA,G}=(RM+D_{DG})/e_{N}=P_{$}(RM+D_{DG})/(RER P_{LC})

or

_{$}C=(RM+Intx_{MA,G}+D_{DG})/e_{N}=P_{$}(RM+Intx_{MA,G}+D_{DG})/(RER P_{LC})

Also and as previously described,

Mₙ[(1+(π′/(1+π′))e^{-r*τ}N(d₂))/N(d₁)]=Y P_{LC}

MₙV=P_{LC}Y

Income Velocity of Money=V=[(1+(π′/(1+π′))e^{-r*τ}N(d₂))/N(d₁)]

Mₙ=mmRM, as is common in macroeconomics

mm=money multiplier related to Mₙ

So,

RM=Y P_{LC}/[mm(1+(π′/(1+π′))e^{-r*τ}N(d₂))/ N(d₁)]

And thus,

_{$}C=({Y P_{LC}/[mm(1+(π′/(1+π′))e^{-r*τ}N(d₂))/N(d₁)]}+Intx_{MA,G}+D_{DG})/e_{N}

=P_{$}({Y P_{LC}/[mm(1+(π′/(1+π′))e^{-r*τ}N(d₂))/N(d₁)]}

+Intx_{MA,G}+D_{DG})/(RER P_{LC})

This can be formulated in using one asset or two assets for G & MA

Equilibrium Equation with One G & MA Asset Formulation

P_{$}({Y P_{LC}/[mm(1+(π′+(1+π′))e^{-r*τ}N(d₂))/N(d₁)]}

+Intx_{MA,G}+D_{DG})/(RER P_{LC})

=_{$}ImV_{G+CB,0}[N(b_{1GCBImV})]−{D_{FGNT}+α_{GF}(D_{FGLT})}e^{-r*τ}[N(b_{2GCBImV})]+_{$}Intx_{MA,G}

({Y P_{LC}/[mm(1+(π′/(1+π′))e^{-r*τ}N(d₂))/N(d₁)]}+Intx_{MA,G}+D_{DG})/e_{N}

=_{$}ImV_{G+CB,0}[N(b_{1GCBImV})]−{D_{FGNT}+α_{GF}(DFGLU )}e^{-r*τ}[N(b_{2GCBImV})]+_{$}Intx_{MA,G}

where,

_{$}σ_{AGCB}=(σ²_{AGCB}+σ²_{ER}−2 ρ_{ER,ImV} σ_{AGCB})^{½}

b_{1GCBImV}=[1n((_{LC}V_{G+CB,0}/e_{N,0})/{D_{FGNT}+α_{GF}(D_{FGLT})})+(r*−q−2ρ_{ER,ImV} σ_{ER}

σ_{AGCB}+(σ²_{AGCB}+σ²ₑₙ)/2)τ]/(σ²_{AGCB}+σ²_{ER}−2 ρ_{ER,ImV} σ_{ER} σ_{AGCB})τ^{½}

b_{2GCBImV}=b_{1GCBImV}−(σ²_{AGCB}+σ²_{ER}−2 ρ_{ER,ImV} σ_{ER} σ_{AGCB})τ^{½}

Equilibrium Equation with Two G & MA Asset Formulation

P_{$}({Y P_{LC}/[mm(1+(π′(1+π′))e^{-r*τ}N(d₂))/N(d₁)]}

+Intx_{MA,G}+D_{DG}) (RER P_{LC})

=*NFA_{MA}exp(−δ₁T) {N[w₃]−N₂[−w₁; w₃; ρ₁]}

+_{$}Im_{DAV}exp(−δ₂T) {N[w₄]−N₂[−w₂; w₄; ρ₂]}

+{D_{FGNT}+α_{GF}(D_{FGLT})}exp(−r* T) N₂[−w₁+σ₁T^{½}; −w₂+σ₂T^{½}; ρ₁₂]

−{D_{FGNT}+α_{GF}(D_{FGL})}exp(−r* T)≡_{$}C_{TwoAsset}

({Y P_{LC}/[mm (1+(π′/(1+π′))e^{-r*τ}N(d₁)]}+Intx_{MA,G}+D_{DG})/e_{N}

=*NFA_{MA} exp(−δ₁T){N[w₃]−N₂[−w₁; w₃; ρ₁]}

+_{$}ImDAV exp(−δ₂T){N[w₄]−N₂[−w₂; w₄; ρ₂]}

+{D_{FGNT}+α_{GF}(D_{FGLT})}exp(−r* T) N₂[−w₁+σ₁T^{½}; −w₂+σ₂T^{½}; ρ₁₂]

−{D_{FGN}+α_{GF}(D_{FGLT})}exp(−r* T)≡_{$}C_{TwoAsset}

Where,

_{$}ImDAV=λDA/e_{N,0}

*NFA_{MA}=NFA_{MA}+IMF/CCL

_{$}ImDAV+*NFA_{MA}=[NFA_{MA}e_{N,0}+IMF/CCL e_{N,0}

+λ{NG_{Rev}+ΔNG_{Rev}−ΣⱼP_{Bj}−Σⱼ FSCEO_{Bj+Σ}ⱼDC_{Bj}}]/e_{N,0}

Σ=((σ₁²+σ₂²−2 ρ₁₂ σ₁ σ₂)^{½}

ρ₁=(ρ₁₂ σ₂−σ₁)/Σ

ρ₂=(ρ₁₂ σ₁−σ₂)/Σ

w₁={1n (*NFA_{MA}/{D_{FGNT}+α_{GF}(D_{FGLT})})+(r*−δ₁+0.5σ₁²)T}/σ₁T^{½}

w₂={1n (_{$}ImDAV/{D_{FGNT}+α_{GF}(D_{FGLT})})+(r*−δ₂+0.5σ₂²)T}/σ₂T^{½}

w₃={1n (*NFA_{MA}/_{$}ImDAV)+(δ₂−δ₁+0.5Σ²)T}/ΣT^{½}

w₄={1n (_{$}ImDAV/*NFA_{MA})+(δ₁−δ₂+0.5Σ²)T}/ΣT^{½}

δ₁=dividend for asset 1, in this case for NFA is 0 or earning the r*, so=−r*

δ₂=dividend for asset 2, in this case for ImDAV, is close to r or q the dividend payed from the fiscal asset related to domestic debt. These economy-equilibrium equations can be used for projections, scenarios, analysis of past relationships, for evaluating risk and changes in expectations and define the IS and LM curves in macroeconomic analysis, based on this macro financial risk option and contingent claims formulation.

Macro Financial Forward Risk Neutral Valuation

The above equilibrium equations can be used to get forward values at future times.

RERₜ₊₁=[RERₜ+α_{RER}(RER_{EQ,t}−RERₜ)][1+((r−π)−(r*−π*))+Risk Premium]

For floating exchange rate: 1/e_{N,τ}=(1/e_{N,0})e^{(r*-r-risk premium)τ}

For fixed exchange rate: 1/e_{N,τ}=(1/e_{N,0})

Price level at t+1 is one plus inflation times price level at t. If there is a forward market for the exchange rate, this value can be used. For the option values, E_{$}[_{LC}V_{G+CB}], _{LC}V_{G+CB} can be adjusted for the change in the numeraire currency. The disclosed technique can include any standard procedure used in derivative pricing techniques to value a derivative when the currency or numeraire is changed. For example, _{LC}V_{G+CB} can be multiplied by a factor exp(ρ_{ER,ImV} σ_{ER} σ_{AGCB})t and divided by the exchange rate to give its value in the numeraire currency (FX or $).

E_{$}[_{LC}V_{G+CB}(t)]=(_{LC}V_{G+CB,0} exp(ρ_{ER,ImV}σ_{ER} σ_{AGCB})t)/e_{N,t},

A related set of relationships include

N⁻¹[((1−e^{-SsovFX τ})/LGD)−((_{$}μ_{A,GCB}−r*)/σ_{A,GCB})τ^{½}]=(−ADBG)

ADGB=((1/e_{N,0}e^{(r*-r)τ})(_{LC}ImV_{G+CB,0})e^{(μ+ρA, eN σA σeN)τ})

−{D_{FGNT}+α(D_{FGLT})})/σ_{A,GCB}

s_{SOVFX} is observed sovereign spread, LGD is loss given default, ADBG see definitions, _{$}μ_{A,GCB} return on G and MA asset.

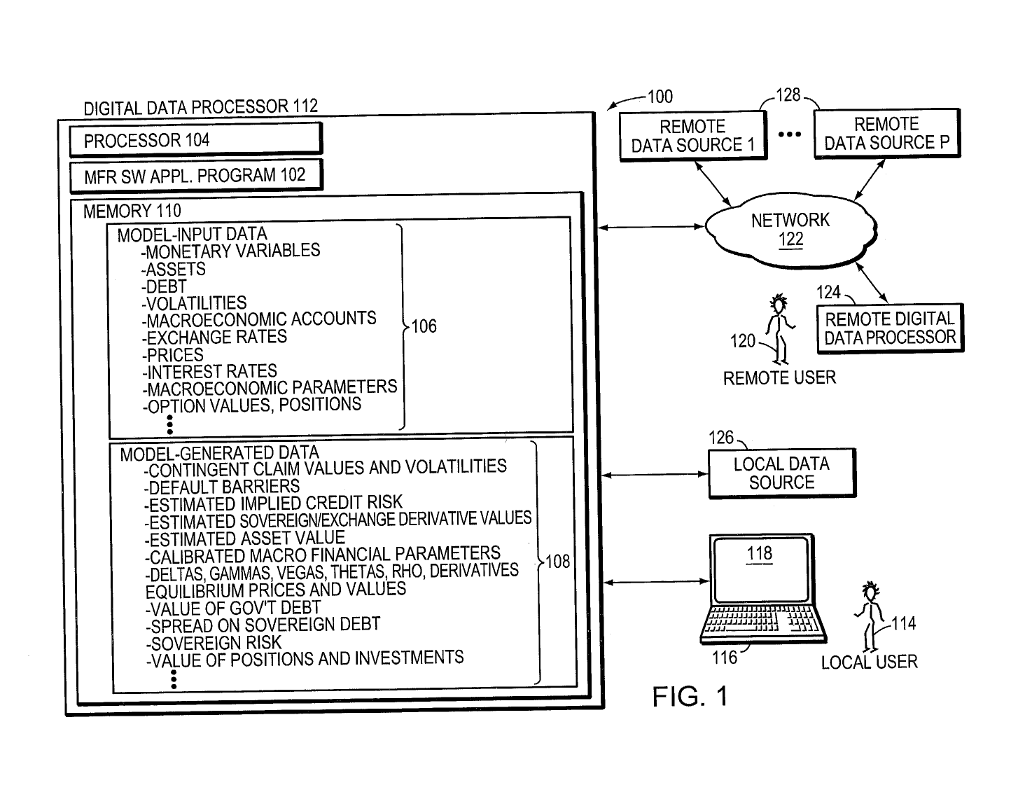

In one illustrative embodiment and with reference to FIG. 1, a risk analysis/modeling system 100 capable of providing a macro financial risk framework for analyzing and evaluating sovereign, sector, and/or portfolio risk can include a macro financial risk software application program 102 executed by a processor 104 within an execution environment (which includes, for example, at least some instructions associated with the application program 102, software libraries, model-input data 106, model-generated data 108, other variables and constants, and/or any other elements needed for the proper operation of the application program 102) in a memory 110 of a digital data processing device 112.

The digital data processing device 112 can be a personal computer, computer workstation (e.g., Sun, HP), laptop computer, server computer, mainframe computer, handheld device (e.g., personal digital assistant, Pocket PC, etc.), information appliance, programmable logic controller, or any other type of generic or special-purpose, processor-controlled device capable of receiving, processing, and/or transmitting digital data. A processor 104 refers to the logic circuitry that responds to and processes instructions (e.g., the instructions provided by the software application program 102) that drive digital data processing devices and can include, without limitation, a central processing unit, an arithmetic logic unit, an application specific integrated circuit, a task engine, and/or any combinations, arrangements, or multiples thereof.

The instructions executed by the processor 104 represent, at the lowest level, a sequence of “0's” and “1's” that describe one or more physical operations of the digital data processing device 112. These instructions can be pre-loaded into a programmable memory (not shown) (e.g., EEPROM) that is accessible to the processor 104 and/or can be dynamically loaded into/from one or more volatile (e.g., RAM, cache, etc.) and/or non-volatile (e.g., hard drive, etc.) memory elements 110 communicatively coupled to the processor 104. The instructions can, for example, correspond to the initialization of hardware within the digital data processing device 112, an operating system (not shown) that enables the hardware elements to communicate with each other under software control and enables other computer programs to communicate with each other, and/or software application programs (such as the MFR software application program 102) that are designed to perform particular functions for a user or other computer programs, such as functions relating to the analysis and modeling of sovereign, sector, and/or portfolio risk.

A local user 114 can interact with a digital data processing device 112 by, for example, viewing a command line, graphical, and/or other type of user interface 118 and entering commands via an input device 116, such as a mouse, keyboard, touch sensitive screen, track ball, keypad, etc. The user interface 118 can be generated by a graphics subsystem (not shown) of the digital data processing device 112, which renders the interface into an on or off-screen surface (e.g., in a video memory and/or on a display screen). Inputs from the user 114 can be received via an input/output subsystem (not shown) of the digital data processing device 112 and routed to the processor 104 via an internal bus (e.g., system bus, or any other type of pathway capable of transmitting data and/or address information) for execution under the control of the operating system (not shown).

Similarly, a remote user 120 can interact with the digital data processing device 112 over a data communications network 122. The inputs from the remote user 120 can be received and processed in whole or in part by a remote digital data processing device 124 collocated with the remote user 120. Alternatively or in combination, the inputs can be transmitted back to and processed by the local digital data processing device 112 or to another digital data processing device via one or more networks using, for example, thin client technology (such as that developed by Citrix Systems, Inc. of Fort Lauderdale, Fla.). The user interface 118 of the local digital data processing device 112 can also be reproduced, in whole or in part, at the remote digital data processing device 124 collocated with the remote user 120 by transmitting graphics information to the remote device 120 and instructing the graphics subsystem (not shown) of the remote device 120 to render and display at least part of the interface 118 to the remote user 120. Network communications between two or more digital data processing devices typically require a network subsystem (e.g., as embodied in a network interface card) (not shown) to establish the communications link between the devices.

Data communications networks can comprise a series of network nodes (e.g., the local and remote digital data processing devices 112, 124) that can be interconnected by network devices and communication lines (e.g., public carrier lines, private lines, satellite lines, etc.) that enable the network nodes to communicate. The transfer of data (e.g., packets) between network nodes can be facilitated by network devices, such as routers, switches, multiplexers, bridges, gateways, etc., that can manipulate and/or route data from a source node to a destination node regardless of any dissimilarities in the network topology (e.g., bus, star, token ring), spatial distance (local, metropolitan, or wide area network), transmission technology (e.g., TCP/IP, Systems Network Architecture), data type (e.g., data, voice, video, or multimedia), nature of connection (e.g., switched, non-switched, dial-up, dedicated, or virtual), and/or physical link (e.g., optical fiber, coaxial cable, twisted pair, wireless, etc.) between the source and destination network nodes.

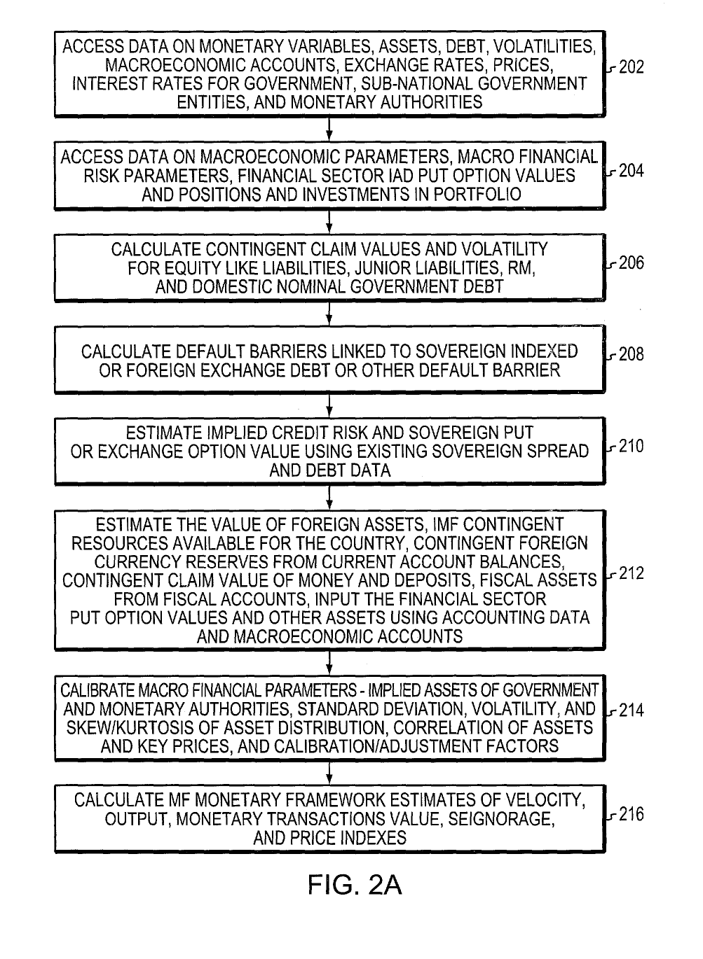

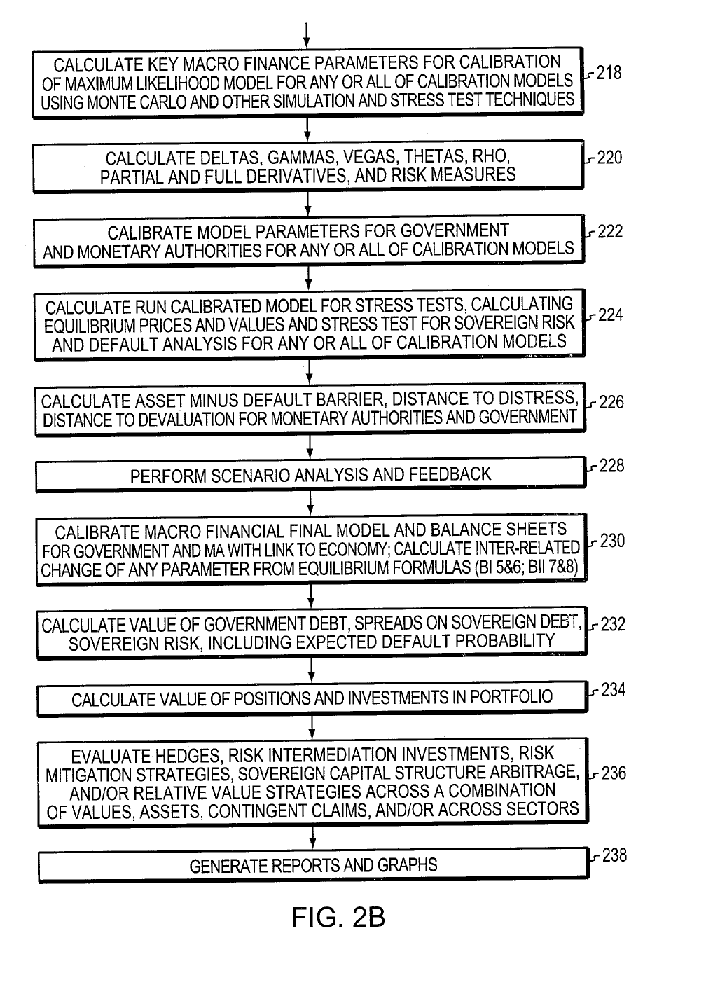

In one illustrative operation and with reference to FIGS. 1 and 2A-2B, the MFR software application program 102 accesses at least some of the model-input data 106 stored in the memory 110 of the digital data processing device 112 (202, 204). The model-input data 106 can include data associated with, for example, monetary variables, assets, debt, volatilities, macroeconomic accounts, exchange rates, prices, interest rates, macroeconomic parameters, option values and positions, portfolio investments, and/or any other type of data useful in evaluating economic/financial risk. In one embodiment, the model-input data 106 can be provided to the memory 110 from one or more local data sources 126 and/or from one or more remote data sources 128. The model-input data 106 can be, for example, in the form of one or more electronic files, streaming real-time data, etc., and can be obtained from any type of local and/or remote data sources 126, 128 accessible by the digital data processing device 112, such as a CD-ROM, CD Jukebox, DVD, magnetic tape, floppy diskette, floptical diskette, internal hard drive, external hard drive, networked storage device, and/or any other type of computer accessible and computer readable medium/device.

The MFR software application program 102 can process at least some of the model-input data 106 by providing instructions that, when executed by the processor 104, apply at least some of the relationships described in this disclosure to the model-input data 106 to form the model-generated data 108. The model-generated data 108 can be used to analyze and model economic/financial risk related to sovereigns, industry sectors, and/or investment portfolios and can include, for example, contingent claim values and volatilities, default barriers, estimated implied credit risk, estimated sovereign/exchange derivative values, estimated asset values, calibrated macro financial parameters, deltas, gammas, Vegas, thetas, rho, derivatives, equilibrium prices and values, value of government debt, spread on sovereign debt, sovereign risk, value of positions and investments, etc. Although the model-generated data 108 is described herein as being generated on the local digital data processing device 112, those skilled in the art will recognize that some or all of the model-generated data 108 can be generated by software processes associated with the MFR software application program 102 on one or more remote digital data processing devices 124 and/or can otherwise be provided by local data sources 126, remote data sources 128, and/or by one or more local or remote users 114, 120. Similarly instructions and software processes of the software application program 102 can be executed by one or more local and/or remote digital data processing devices 112, 124.

In one illustrative embodiment and with reference also to previously-described relationships/formulas, the MFR software application program 102 can calculate contingent claim values and volatilities for equity like liabilities, junior liabilities, RM, and/or domestic nominal government debt (206) and/or can calculate default barriers linked to sovereign-indexed or foreign exchange debt (208). The application program 102 can also estimate implied credit risk and sovereign put or exchange option values using existing sovereign spread and debt data (210) and/or can use accounting data and macroeconomic accounts to estimate the value of foreign assets, IMF contingent resources available for a country, contingent foreign currency reserves from current account balances, contingent claim value of money and deposits, fiscal assets, and/or financial sector put option values (212). The application program 102 can then apply previously-described relationships/formulas used in blocks 206-212 to calibrate macro financial parameters, such as the implied assets of government and monetary authorities, standard deviation, volatility, and skew/kurtosis of asset distribution, correlation of assets and prices, and/or calibration/adjustment factors (214).

The application program 102 can apply previously-described relationships/formulas to calculate estimates of velocity, output, monetary transactions value, seignorage, and/or price indexes (216). Macro financial parameters can also be calculated to calibrate one or more models using, for example, Monte Carlo and/or other simulation and stress test techniques (218). The application program 102 can further calculate deltas, gammas, vegas, thetas, rho, partial and full derivatives and/or risk measures (220) and can use these parameters together with the results of blocks 214-218 to calibrate parameters for government and monetary authority models (222). The equilibrium prices and values for the calibrated model of block 222 can then be calculated for a variety of stress tests and models (224). The application program 102 can calculate an asset to default barTier, distance to distress, and/or distance to devaluation for government and monetary authorities (226). The application program 102 can also perform scenario analysis and provide feedback for the operations described in blocks 214-220 (228).

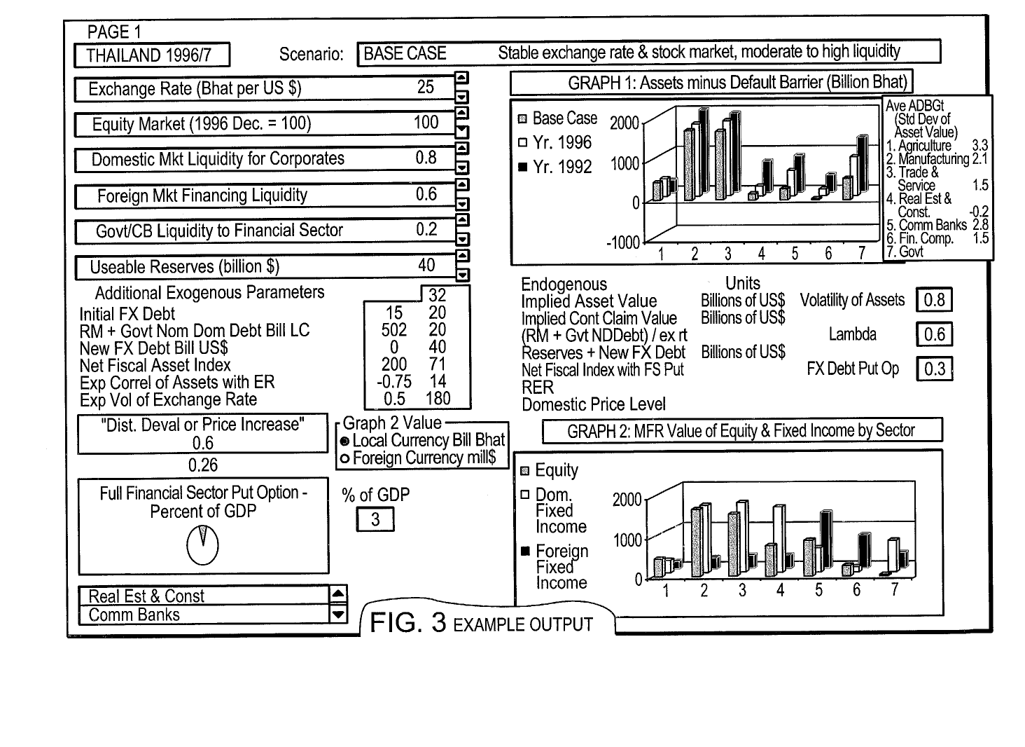

The application program 102 can then calibrate the macro financial model into a final model and generate balance sheets for government and monetary authorities that include links to an economy, as well as, calculate any inter-related changes to any parameter from the previously described equilibrium formulas (230). The application program 102 can also calculate the value of government debt, spreads on sovereign debt, sovereign risk (including expected default probability) (232), as well as, calculate the value of positions and investments in a portfolio (234), and/or evaluate hedges, risk intermediation investments, risk mitigation strategies, sovereign capital structure arbitrage, and/or relative value strategies across a combination of values, assets, and contingent claims and across sectors (236). The application program can display one or more inputs and/or outputs of the macro financial framework by generating reports and graphs that can be printed, routed (e.g., via email or facsimile), displayed within the user interface 118, or otherwise provided to local and/or remote users 114, 120 (238). In one illustrative embodiment, aspects of the macro financial framework can be displayed to a local user 114 via the user interface 118 of the local digital data processing device 112, as shown in FIG. 3.

All patents, patent applications, books, or any other publications mentioned herein are hereby incorporated by reference in their entirety as if each individual patent, patent application, book or was specifically and individually indicated to be incorporated by reference. In case of conflict, the present application, including any definitions herein, will control.

Although the present invention has been described with reference to specific details, it is not intended that such details should be regarded as limitations upon the scope of the invention, except as and to the extent that they are included in the accompanying claims. For example, those skilled in the art will appreciate that the various illustrative equations and relationships disclosed herein can be modified to include more parameters, fewer parameters, one or more different parameters, and/or different combinations of parameters, etc.

What is claimed is:

1. A method of assessing risk, comprising:
accessing macroeconomic data;
calculating at least one contingent claim value associated with the macroeconomic data;
forming at least one economic balance sheet using the contingent claim value; and
displaying at least one entry of the economic balance sheet in a user interface of a digital data processing device.

2. The method of claim 1 further comprising:
calibrating at least one parameter associated with a risk model using the contingent claim value;
calculating equilibrium values associated with the risk model; and
forming the economic balance sheet using the contingent claim value and equilibrium values.

3. The method of claim 2 wherein the calibrated parameter associated with the risk model is one of a share of near term debt, a share of a long term debt, a policy effectiveness parameter, a volatility of a liability, a risk free discount rate, a sovereign risk premium, a default recovery rate, an asset correlation parameter, and a tail factor.

4. The method of claim 1 wherein the economic balance sheet includes data corresponding to a first sector.

5. The method of claim 4 further comprising:
forming a second economic balance sheet using the contingent claim value, the second economic balance sheet including data corresponding to a second sector; and
associating at least some of the data corresponding to the first sector with at least some of the data corresponding to the second sector.

6. The method of claim 1 wherein the macroeconomic data corresponds to at least one of a government and a monetary authority.

7. The method of claim 1 wherein the contingent claim value is associated with at least one of a monetary transactions value and money.

8. The method of claim 1 wherein the contingent claim value corresponds to an implicit call option on assets of at least one of a government and a monetary authority.

9. The method of claim 1 further comprising:
determining the contingent claim value from at least one of a default bartier, a monetary transactions value, and an amount of RM.

10. The method of claim 9 further comprising:
estimating the monetary transactions value using a foregone income.

11. The method of claim 1 further comprising:
determining the contingent claim value from at least one of a real exchange rate, a sovereign local currency debt, a price index, and an amount of RM.

12. A software application program for assessing risk, comprising:
instructions affecting the operation of a processor in a digital data processing device, the processor executing at least some of the instructions to
access macroeconomic data;
calculate at least one contingent claim value associated with the macroeconomic data;
form at least one economic balance sheet using the contingent claim value; and
display at least one entry of the economic balance sheet in a user interface of a digital data processing device.

13. The program of claim 12 wherein the processor executes at least one of the instructions to:
calibrate at least one parameter associated with a risk model using the contingent claim value;
calculate equilibrium values associated with the risk model; and
form the economic balance sheet using the contingent claim value and equilibrium values.

14. The program of claim 13 wherein the calibrated parameter associated with the risk model is one of a share of near term debt, a share of a long term debt, a policy effectiveness parameter, a volatility of a liability, a risk free discount rate, a sovereign risk premium, a default recovery rate, an asset correlation parameter, and a tail factor.

15. The program of claim 12 wherein the economic balance sheet includes data corresponding to a first sector.

16. The program of claim 15 wherein the processor executes at least one of the instructions to:
form a second economic balance sheet using the contingent claim value, the second economic balance sheet including data corresponding to a second sector; and
associate at least some of the data corresponding to the first sector with at least some of the data corresponding to the second sector.

17. The program of claim 12 wherein the macroeconomic data corresponds to at least one of a government and a monetary authority.

18. The program of claim 12 wherein the contingent claim value is associated with at least one of a monetary transactions value and money.

19. The program of claim 12 wherein the contingent claim value corresponds to an implicit call option on assets of at least one of a government and a monetary authority.

20. The program of claim 12 wherein the processor executes at least one of the instructions to:
determine the contingent claim value from at least one of a default barrier, a monetary transactions value, and an amount of RM.

21. The program of claim 20 wherein the processor executes at least one of the instructions to:
estimate the monetary transactions value using a foregone income.

22. The program of claim 12 wherein the processor executes at least one of the instructions to:
determine the contingent claim value from at least one of a real exchange rate, a sovereign local currency debt, a price index, and an amount of RM.

23. A system for assessing risk, comprising:
a means for accessing macroeconomic data;
a means for calculating at least one contingent claim value associated with the macroeconomic data;
a means for forming at least one economic balance sheet using the contingent claim value; and
a means for displaying at least one entry of the economic balance sheet in a user interface of a digital data processing device.

24. The system of claim 23 further comprising:
a means for calibrating at least one parameter associated with a risk model using the contingent claim value;
a means for calculating equilibrium values associated with the risk model; and
a means for forming the economic balance sheet using the contingent claim value and equilibrium values.

25. The system of claim 24 wherein the calibrated parameter associated with the risk model is one of a share of near term debt, a share of a long term debt, a policy effectiveness parameter, a volatility of a liability, a risk free discount rate, a sovereign risk premium, a default recovery rate, an asset correlation parameter, and a tail factor.

26. The system of claim 23 wherein the economic balance sheet includes data corresponding to a first sector.

27. The system of claim 26 further comprising:
a means for forming a second economic balance sheet using the contingent claim value, the second economic balance sheet including data corresponding to a second sector; and
a means for associating at least some of the data corresponding to the first sector with at least some of the data corresponding to the second sector.

28. The system of claim 23 wherein the macroeconomic data corresponds to at least one of a government and a monetary authority.

29. The system of claim 23 wherein the contingent claim value is associated with at least one of a monetary transactions value and money.

30. The system of claim 23 wherein the contingent claim value corresponds to an implicit call option on assets of at least one of a government and a monetary authority.

31. The system of claim 23 further comprising a means for determining the contingent claim value from at least one of a default barrier, a monetary transactions value, and an amount of RM.

32. The system of claim 31 further comprising a means for estimating the monetary transactions value using a foregone income.

33. The system of claim 23 further comprising a means for determining the contingent claim value from at least one of a real exchange rate, a sovereign local currency debt, a price index, and an amount of RM.
